(19) United States
(12) Patent Application Publication
(10) Pub. No.: US 2025/0161936 A1
(43) Pub. Date: May 22, 2025

(54) MICROFLUIDIC DEVICES

(71) Applicant: LumiraDx UK Ltd., London (GB)

(72) Inventors: Badr Aman Khan, Bedford (GB); Usman Ali Khan, Bedford (GB); Geoffrey Frank Hall, Fortrose (GB); Phill Lowe, Tullibody (GB); Steven Alexander Keatch, Stirling (GB); Christopher John Slevin, Edinburgh (GB); Brian McGuigan, Doune, Stirling (GB); Aman Murtaza Khan, Bedford (GB)

(21) Appl. No.: 18/833,329

(22) PCT Filed: Jan. 27, 2023
(86) PCT No.: PCT/GB2023/050189

§ 371 Date: Jul. 25, 2024

Related U.S. Application Data
(60) Provisional application No. 63/303,858, filed on Jan. 27, 2022.

(51) Int. Cl. B01L 3/00

(52) U.S. Cl. CPC B01L 3/502707; B01L 2200/16; B01L 2300/0887; B01L 2300/10; B01L 2300/12; B01L 2400/0439

(57) ABSTRACT

A microfluidic network of a polymeric microfluidic strip includes a liquid sample input port, a reagent zone, a detection zone, and a compressible chamber in fluidic communication via the microfluidic network. A polymer layer overlies the microfluidic network. When the microfluidic strip is inserted into a diagnostic reader, a mechanical actuator is configured to compress the chamber to expel gas from the chamber and move liquid sample in the microfluidic network toward the input port. The actuator decompresses the chamber to draw gas into the chamber and move liquid sample in the microfluidic network toward the chamber. To decrease the tension experienced by the polymer layer when compressed by the mechanical actuator, the polymer layer includes one or more tension relief zones adjacent the chamber. The tension relief zones may include laser-ablated slits extending at least partially through the polymer layer.

### CROSS-REFERENCE TO RELATED APPLICATIONS

This application claims the benefit of and priority to U.S. Provisional Application No. 63/303,858, filed Jan. 27, 2022, the entire contents of which are incorporated by reference herein. International Application No. PCT/US2021/013325 filed Jan. 13, 2021 (the “'325 application”) is incorporated herein by reference in its entirety.

### FIELD OF THE INVENTION

The present invention relates to microfluidic devices, e.g., microfluidic strips, and to methods for manipulating liquids and/or gases within such devices.

### BACKGROUND OF THE INVENTION

A microfluidic device (e.g., a microfluidic strip) having a microfluidic channel network may be used to, e.g., determine the presence or amount of one or more targets in a sample liquid and/or determine a physiological property of a sample liquid. Such devices may be used in conjunction with a reader, which operates the device to, for example, perform fluidic and/or detection functions in the determination of the target or physiological, physiochemical, or other property of the sample.

Manipulation of a sample and/or other liquids within the cartridge is often performed, for example, in order to ensure that the sample contacts, mixes, and/or reacts with reagents which have been deposited within or introduced to the cartridge.

### SUMMARY OF THE INVENTION

In embodiments, a method of manipulating a liquid disposed within a microfluidic network of a microfluidic device, e.g., a microfluidic strip, includes compressing and/or decompressing a portion of a flexible polymer layer overlying or underlying a gas chamber of the microfluidic network. The gas of the gas chamber is in gaseous communication with a liquid-gas interface of the liquid, e.g., a liquid sample, disposed within the microfluidic network. The polymer layer includes one or more tension relief zones configured to reduce a tension experienced by the portion of the polymer layer overlying or underlying the gas chamber when the portion of the polymer layer is compressed as compared to the tension that would be experienced by the portion of the polymer layer overlying or underlying the gas chamber when the portion of the polymer layer is compressed in the absence of the one or more tension relief zones.

In embodiments, of the method of manipulating a liquid, the gas chamber has a perimeter (p1) defined at least in part by internal side walls thereof. The perimeter p1 of the gas chamber as defined by the internal side walls thereof may be about 7.5 cm or less, about 5 cm or less, about 4 cm or less or about 3.5 cm or less. The perimeter p1 of the gas chamber as defined by the side walls may be about 1 cm or more, about 1.5 cm or more, about 2 cm or more, or about 2.5 cm or more. The one or more tension relief zones may extend, in aggregate, for a length that is at least about 20%, at least about 30%, at least about 40%, at least about 45%, at least about 50%, at least about 55%, at least about 60%, at least about 65%, or at least about 70% of the perimeter (p1) as defined by the internal side walls. The one or more tension relief zones of the flexible polymer layer may be disposed a distance that is, on average, about 5 mm or less, about 4 mm or less, about 3 mm or less, about 2 mm or less, about 1.5 mm or less, about 1 mm or less, about 0.75 mm or less, or about 0.5 mm or less from the internal side walls of the gas chamber. The one or more tension relief zones of the flexible polymer layer may be disposed a distance that is, on average, at least about 0.25 mm, about 0.35 mm, or about 0.5 mm from the internal side walls of the gas chamber. In embodiments, a percentage of at least about 20%, at least about 30%, at least about 40%, at least about 45%, at least about 50%, at least about 55%, at least about 60%, at least about 65%, or at least about 70% of the perimeter p1 as defined by the internal side walls has a tension relief zone disposed within a distance of about 5 mm or less, about 4 mm or less, about 3 mm or less, about 2 mm or less, about 1.5 mm or less, about 1 mm or less, about 0.75 mm or less, or about 0.5 mm or less from the internal side walls of the gas chamber. In embodiments, a percentage of at least about 20%, at least about 30%, at least about 40%, at least about 45%, at least about 50%, at least about 55%, at least about 60%, at least about 65%, or at least about 70% of the perimeter p1 as defined by the internal side walls has a tension relief zone disposed within a distance of at least about 0.25 mm, at least about 0.35 mm, or at least about 0.5 mm from the internal side walls of the gas chamber.

In embodiments of the method of manipulating a liquid, the perimeter p1 as defined by the internal side walls of the gas chamber is between about 25 and 40 mm, e.g., about 30 mm, and one or more tension relief zones having an aggregate length of between about 15 and 28 mm, e.g., about 22 mm, are disposed within a distance of between about 250 and 750 μm, e.g., about 500 μm of the internal side walls. In embodiments, each of one or more tension relief zones is disposed within the aforementioned distances of an internal side wall of each of a plurality of separate gas chambers, e.g., at least two gas chambers. Each of such gas chambers may be in gaseous communication with a respective different analysis channel.

In embodiments of the method of manipulating a liquid, the flexible polymer layer having the one or more tension relief zones has an average thickness, taken along an axis that is perpendicular to a major plane of the microfluidic device, of at least about 50 μm, at least about 75 μm, or at least about 100 μm. The average thickness along the polymer layer taken along the axis that is perpendicular to the major plane of the microfluidic device may be about 300 μm or less, about 250 μm or less, about 200 μm or less, about 175 μm or less, about 150 μm or less, or about 125 μm or less. The absolute difference between the minimum and maximum thickness of the flexible polymer layer taken along the axis that is perpendicular to the major plane of the microfluidic device may be about 300 μm or less, about 250 μm or less, about 200 μm or less, about 175 μm or less, about 150 μm or less, or about 125 μm or less. For example, the flexible polymer layer may be a flexible polymer sheet having a uniform thickness throughout except for regions of the sheet occupied by a sample input port of the microfluidic device, the one or more tension relief zones, and exit ports of vents to the microfluidic network. In such regions, the flexible polymer sheet has a reduced thickness or is entirely absent. The absolute difference between the minimum and maximum thickness of the microfluidic device, e.g., microfluidic device, taken along the axis that is perpendicular to the major plane of the microfluidic device may be about 300 μm or less, about 250 μm or less, about 200 μm or less, about 175 μm or less, about 150 μm or less, or about 125 μm or less.

In embodiments of the method of manipulating a liquid, the gas chamber has a height taken along the axis that is perpendicular to the major plane of the microfluidic device that is about 500 μm or less, about 400 μm or less, about 300 μm or less, about 250 μm or less, about 200 μm or less or about 175 μm or less. The gas chamber may have a height taken along the axis that is perpendicular to the major plane of the microfluidic device of at least about 50 μm, at least about 75 μm at least about 100 μm or at least about 115 μm. In embodiments, the gas chamber has a height taken along the axis that is perpendicular to the major plane of the microfluidic device that is between about 100 and 130 μm, e.g., between about 110 and 115 μm.

In embodiments of the method of manipulating a liquid, at least one, e.g., all of the one or more tension relief zones, may include, e.g., may consist of, a groove extending at least partially through the flexible polymer layer along the axis that is perpendicular to the major plane of the microfluidic device. For example, at least a portion of the tension relief zone may extend through at least about 25%, at least about 50%, at least about 75%, at least about 85%, at least about 95%, essentially all the way through, or entirely through the flexible polymer layer. The portion of the tension relief zone that so extends may include at least about 25%, at least about 50%, at least about 75%, at least about 95%, essentially all, or all of the tension relief zone.

In embodiments of the method of manipulating a liquid, at least one, e.g., all of the one or more tension relief zones, may have a width, taken along an axis that is parallel to the major plane of the microfluidic device of about 1000 μm or less, about 750 μm or less, about 500 μm or less, about 300 μm or less, about 250 μm or less, or about 175 μm or less. The width of the tension relief zone taken along the axis that is parallel to the major plane of the microfluidic device may be about 25 μm or more, about 50 μm or more, about 75 μm or more, about 100 μm or more, about 125 μm or more, or about 150 μm or more. The portion of the tension relief zone with such width may include at least about 25%, at least about 50%, at least about 75%, at least about 95%, essentially all, or all of the tension relief zone. In embodiments, the width of the one or more tension relief zones varies as a function of depth along the axis that is perpendicular to the major plane of the microfluidic device such that the aforementioned dimensions represent an average width of the tension relief zone. For example, the width of the tension relief zone may increase from a maximum adjacent an outer surface of the flexible polymer layer to a minimum adjacent an inner opposing surface of the flexible polymer layer.

In embodiments of the method of manipulating a liquid, the gas chamber has a length along an axis parallel to a major plane of the microfluidic device and a width perpendicular to the length and along an axis parallel to the major plane of the microfluidic device. A ratio of a length to the width of the gas chamber (length:width) may be at least about 1.5, at least about 1.75, at least about 2, or at least about 2.25. The ratio of the length to the width of the gas chamber may be about 5 or less, about 4 or less, about 3 or less, or about 2.5 or less. For example, the gas chamber may have a length of about 11 mm and a width of about 4 mm. In embodiments, a tension relief zone may be disposed along the length of the gas chamber only on a first side thereof or on both opposing sides thereof.

In embodiments of the method of manipulating a liquid, the microfluidic device defines a total area in the major plane of the microfluidic device. The flexible polymer layer may occupy at least about 25%, at least about 50%, at least about 75%, at least about 85%, at least about 90%, at least about 95%, or essentially all of the total area of the microfluidic device in the major plane. For example, the flexible polymer layer may occupy essentially all of the total area in the major plane of the microfluidic device excluding an area occupied by a sample input port of the microfluidic device, the one or more tension relief zones, and exit ports of vents to the microfluidic network. In such regions, the flexible polymer sheet has a reduced thickness or is entirely absent.

The flexible polymer layer and the microfluidic device may each define a respective width in the major plane of the microfluidic device. The width of the flexible polymer layer may be within about 5 mm, within about 4 mm, within about 3 mm, within about 2 mm, or within about 1 mm of the width of the microfluidic device. The width of the flexible polymer layer may be essentially the same as the width of the microfluidic device. The flexible polymer layer and the microfluidic device may each define a respective length in the major plane of the microfluidic device. The length of the flexible polymer layer may be within about 5 mm, within about 4 mm, within about 3 mm, within about 2 mm, or within about 1 mm of the length of the microfluidic device. The length of the flexible polymer layer may be essentially the same as the width of the microfluidic device.

In embodiments of the method of manipulating the liquid disposed within the microfluidic network of the microfluidic device, the method includes sensing the state of compression and/or decompression of the flexible polymer layer overlying or underlying the gas chamber. For example, the method may include sensing whether a location of the flexible polymer layer is in a fully compressed state, e.g., whether the location of the flexible polymer layer has been compressed so that an internal surface of the flexible polymer layer is in contact with an opposed internal surface of the gas chamber. The sensing may be performed, for example, by sensing the electrical connectivity between two or more conductive elements (e.g., leads) disposed within the gas chamber. For example, in some embodiments, a first internal surface of the gas chamber includes an electrically conductive contact and a second internal surface, opposed to the first internal surface, includes at least two electrical leads. Upon full operative compression of the flexible polymer layer, the at least two electrical leads contact the electrically conductive contact and are brought into electrical communication, e.g., either directly into electrically conductive contact with one another or indirectly, e.g., via an electrically conductive contact. A sensor disposed in a diagnostic reader configured to operate the microfluidic device senses the electrical connectivity between the electrical leads. In other embodiments, the first internal surface of the gas chamber includes a first electrical lead and the second, opposing internal surface of the gas chamber includes a second electrical lead which become electrically connected upon full operative compression of the flexible polymer layer.

In embodiments, a microfluidic device includes a generally planar substrate, e.g., a microfluidic strip, including a microfluidic network therein. The microfluidic network typically includes one or more features that facilitate the determination of one or more targets in a liquid sample. For example, the microfluidic network may include one or more features that permit the introduction of a liquid sample to the device, the movement of liquid sample within the microfluidic network, the combining of the liquid sample with one or more reagents within the device, and/or the detection of the one or more targets. For example, the microfluidic network may include an input port, a reagent zone, a detection zone, a gas chamber, and/or at least one channel extending between the input port and the gas chamber.

A flexible a polymer layer overlies or underlies a gas chamber of the microfluidic network. The flexible polymer layer is compressible along an axis perpendicular to a major plane of the substrate to reduce an internal volume of the gas chamber. The polymer layer includes one or more tension relief zones configured to reduce a tension experienced by the portion of the polymer layer overlying or underlying the gas chamber when the gas chamber is compressed as compared to the tension that would be experienced by the portion of the polymer layer overlying or underlying the gas chamber when the gas chamber is compressed in the absence of the one or more tension relief zones.

In embodiments of the microfluidic device, the flexible polymer layer, apart from the tension relief zone, has a primary thickness along the axis perpendicular to the major plane of the substrate of between about 50 μm and 150 μm and, within the tension relief zone, the polymer layer has a thickness of from about 0% to about 75% of the primary thickness, e.g., a thickness of from about 0% to about 50% of the primary thickness, a thickness of from about 0% to about 25% of the primary thickness, a thickness of from about 0% to about 15% of the primary thickness, or a thickness of less than about 5% of the primary thickness.

The one or more tension relief zones may include one or more laser ablation zones. For example, each tension relief zone may be created by using a laser to ablate a slit or one or more series of ablated zones, e.g., holes, extending entirely through the flexible polymer layer. Alternatively, each tension relief zone may be created by using a laser to ablate a groove, or series of laser ablated zones, e.g., pits, extending only partially through the flexible polymer layer. The tension relief zone created by laser ablation may have any or all of the features of the tension relief zones disclosed herein, e.g., depth, length, and relationship to the gas chambers of the microfluidic device.

In embodiments of the microfluidic device, the gas chamber has a perimeter p1 defined at least in part by sidewalls therein and the one or more tension relief zones extend for a total distance of at least about 50%, at least about 60%, at least about 70%, or at least about 80% of the perimeter defined by the side walls. The perimeter of the gas chamber defined by the side walls may have a total length of at least about 1 cm, at least about 2 cm, at least about 3 cm, at least about 4 cm, or at least about 5 cm. The perimeter of the gas chamber defined by the side walls may have a total length of about 7.5 cm or less, about 5 cm or less, about 4 cm or less, or about 3 cm or less.

In embodiments of the microfluidic device, the gas chamber has a perimeter defined at least in part by internal side walls thereof and at least about 25%, at least about 50%, at least about 75%, at least about 85%, at least about 95%, essentially all, or all of the length of the tension relief zone is disposed within a distance of about 3 mm or less, about 2 mm or less, about 1.5 mm or less, about 1 mm or less, about 0.75 mm or less, about 0.5 mm or less of the perimeter as defined by the internal side walls.

In embodiments of the microfluidic device, the flexible polymer layer is a first polymer layer and the substrate includes or consists essentially of a laminate of the first polymer layer, a second polymer layer, and an adhesive layer, wherein the adhesive layer is disposed between the first and second polymer layers along the axis perpendicular to the major plane of the substrate and secures the first and second polymer layers with respect to one another. In embodiments of the microfluidic device, the adhesive layer defines internal side walls of the microfluidic network including the gas chamber. The internal side walls may be oriented generally parallel to the axis that is perpendicular to the major plane of the substrate. The adhesive layer may consist essentially of a single layer of adhesive having a first surface in contact with a surface of the first polymer layer and a second surface opposed to the first surface and in contact with a surface of the second polymer layer.

In embodiments of the microfluidic device, a thickness of the adhesive layer along the axis that is perpendicular to the major plane of the substrate is between about 50 and 500 μm, between about 50 and 400 μm, between about 50 and 300 μm, between about 50 and 250 μm, between about 50 and 200 μm, between about 50 and 150 μm, or between about 50 and 125 μm, e.g., about 115 μm.

In embodiments of the microfluidic device, a thickness of the flexible polymer layer that comprises the at least one tension relief zone along the axis that is perpendicular to the major plane of the substrate is between about 50 and 500 μm, between about 50 and 400 μm, between about 50 and 300 μm, between about 50 and 250 μm, between about 50 and 200 μm, between about 50 and 150 μm, or between about 50 and 125 μm, e.g., about 100 μm.

In embodiments of the microfluidic device, an average depth of the tension relief zone along the axis that is perpendicular to the major plane of the substrate is at least about 50%, at least about 60%, at least about 70%, at least about 80%, at least about 90%, at least about 95%, essentially the same as, or entirely through of the thickness of the polymer layer that comprises the at least one tension relief zone. For example, in embodiments of the microfluidic device,
at least about 50%, at least about 60%, at least about 70%, at least about 75%, at least about 85%, at least about 95%, or essentially all of the length of the tension relief zone extends entirely through the polymer layer that comprises the at least one tension relief zone along the axis that is perpendicular to the major plane of the substrate.

In embodiments of the microfluidic device, the average thickness of the substrate along the axis that is perpendicular to the major plane of the substrate is about 2000 μm or less, about 1500 μm or less, about 1000 μm or less, about 750 μm or less, about 500 μm or less, about 400 μm or less, or about 350 μm or less. In embodiments of the microfluidic device, the maximum thickness of the substrate along the axis that is perpendicular to the major plane of the substrate is about 2000 μm or less, about 1500 μm or less, about 1000 μm or less, about 750 μm or less, about 500 μm or less, about 400 μm or less, or about 350 μm or less. In embodiments of the microfluidic device, a maximum difference between a minimum and maximum height of the substrate along the axis that is perpendicular to the major plane of the substrate is no greater than about twice the average thickness of the flexible polymer layer that comprises the at least one tension relief zone. In embodiments of the microfluidic device, a maximum difference between a minimum and a maximum height of the substrate along the axis that is perpendicular to the major plane of the substrate is about 1000 μm or less, about 750 μm or less, about 500 μm or less, about 400 μm or less, about 300 μm or less, about 250 μm or less, about 225 μm or less, about 150 μm or less, or about 125 μm or less.

In embodiments of the microfluidic device, the substrate has a surface area parallel to the major plane of the substrate and the polymer layer that includes the at least one tension relief zone extends over at least about 50%, at least about 60%, at least about 70%, at least about 80%, at least about 90%, at least about 95%, or at least about 97.5% of the surface area. For example, excluding the input port if present, the substrate may have a surface area parallel to the major plane of the substrate and, excluding the input port if present, the polymer layer that comprises the at least one tension relief zone extends over at least about 50%, at least about 60%, at least about 70%, at least about 80%, at least about 90%, at least about 95%, at least about 97.5% of the surface area, or essentially all of the surface area.

In embodiments of the microfluidic device, the microfluidic device includes an input port to the microfluidic network and the input port is the only port of the substrate configured to receive liquids during operation of the device. In embodiments of the microfluidic device, prior to use, the substrate contains no liquids. In embodiments of the microfluidic device, the substrate lacks any reservoir containing a liquid reagent configured to be combined with a sample liquid within the microfluidic network.

In embodiments of the microfluidic device, the substrate is flexible. For example, in embodiments the substrate can be flexed about a curve having a radius of curvature of about 7.5 cm or less, about 5 cm or less, about 4 cm or less, about 3 cm or less, or about 2.5 cm or less without breaking and/or rendering the substrate nonfunctional.

In embodiments of the microfluidic device, the gas chamber has an internal height along the axis that is perpendicular to the major plane of the substrate of about 500 μm or less, about 400 μm or less, about 300 μm or less, about 250 μm or less, about 200 μm or less, about 150 μm or less or about 125 μm or less. In embodiments of the microfluidic device, the gas chamber has an internal height along the axis that is perpendicular to the major plane of the substrate of at least about 50 μm, at least about 75 μm, at least about 100 μm, or at least about 115 μm.

In embodiments of the microfluidic device, the gas chamber has an internal area parallel to the major plane of the substrate of at least about 1 cm², at least about 1.5 cm², at least about 2 cm², at least about 3 cm², or at least about 4 cm². In embodiments of the microfluidic device, the gas chamber has an internal area parallel to the major plane of the substrate of about 10 cm² or less, about 7.5 cm² or less, about 6 cm² or less, about 5 cm² or less, or about 4 cm² or less.

In any of the embodiments of the microfluidic device, the substrate of the microfluidic device is a microfluidic strip, e.g., a flexible microfluidic strip. In any of the embodiments of the microfluidic device, the flexible polymer layer may be a flexible polymer sheet.

In embodiments of the microfluidic device, the gas chamber is a first gas chamber and the microfluidic network comprises a second gas chamber. The polymer layer including the at least one tension relief zone overlies or underlies the second gas chamber, an outer surface of the polymer layer overlying or underlying the second chamber is compressible along the axis perpendicular to the major plane of the substrate to reduce an internal volume of the second chamber and the polymer layer includes one or more tension relief zones configured to reduce a tension experienced by the portion of the polymer layer overlying or underlying the second gas chamber when the second gas chamber is compressed as compared to the tension that would be experienced by the portion of the polymer layer overlying or underlying the second gas chamber when the second gas chamber is compressed in the absence of the one or more tension relief zones.

In embodiments, a medical diagnostic instrument includes a microfluidic device of any of the foregoing embodiments disposed at least partially within the diagnostic instrument in an operable position; a gas chamber actuation mechanism configured to move liquid sample within the microfluidic network by compressing the gas chamber to expel gas from the gas chamber and into the microfluidic network or decompressing the gas chamber to draw gas from the microfluidic network into the chamber; and a detection system configured to detect a signal indicative of the presence of a target within a sample applied to the input port of the substrate.

In embodiments, a method of manipulating a liquid, e.g., a sample liquid, disposed within a microfluidic network of a microfluidic device includes compressing and/or decompressing each of multiple spaced apart locations (gas chamber branches) of a flexible polymer layer overlying or underlying a gas chamber of the microfluidic network. The compressing and/or decompressing may be performed using a plurality of actuators, e.g., mechanical and/or piezoelectric actuators as disclosed in the '325 application. Each actuator may include an actuator foot that contacts an external surface of the flexible polymer layer associated with a respective spaced apart location of the gas chamber. The compression and/or decompression of each spaced apart location may be performed with an actuator that is different from, e.g., independently actuatable from, an actuator used to compress and/or decompress the other spaced apart locations. Each actuator may be configured to compress and/or decompress the spaced apart locations synchronously with the compression and/or decompression by the other actuators. Each actuator may be configured to synchronously oscillate the compression state of the polymer layer. The synchronous oscillation may be performed while each actuator is compressing or decompressing the flexible polymer layer or during such compression or decompression. The synchronous oscillation may be performed at acoustic frequencies, e.g., at a frequency between about 500 Hz and 1200 Hz.

In embodiments in which method includes compressing and/or decompressing each of multiple spaced apart locations of the flexible polymer layer, the number of spaced apart locations may be at least 2, at least 3, or at least 4. The number of spaced apart locations may be 6 or fewer, 5 or fewer, or 4 or fewer. The flexible polymer layer may include at least one tension relief zone disposed between at least some of the spaced apart locations, e.g., between at least 2, at least 3, or at least 4 of the spaced apart locations. For example, the at least one tension relief zones may be disposed within the flexible polymer layer overlying or underlying an internal support or wall at least partially separating adjacent spaced apart locations.

In embodiments using an actuator to perform the compressing, decompressing, and/or oscillating, the actuator may contact an outer surface of the flexible polymer layer overlying or underlying the gas chamber. An area of contact between the actuator, e.g., an actuator foot of the actuator, and the outer surface of the flexible polymer layer may be at least about 5%, at least about 7.5%, at least about 10%, or at least about 12.5% of the area of the gas chamber as defined within the perimeter p1 of the gas chamber. An area of contact between the actuator, e.g., actuator foot, and the outer surface of the flexible polymer layer may be about 25% or less, about 20% or less, or about 15% or less of the area of the gas chamber as defined within the perimeter p1 of the gas chamber. For example, the gas chamber may have an area defined within the perimeter p1 thereof of between about 35 and 50 mm² and the area of contact between the actuator, e.g., actuator foot, and the outer surface of the flexible polymer layer may be between about 4 and 8 mm².

In embodiments in which method includes compressing and/or decompressing each of multiple spaced apart locations of the flexible polymer layer, the gas chamber may include an internal support disposed between each of multiple of the spaced apart locations of the polymer layer. For example, each internal support may include an extension of the material defining the side walls of the gas filed chamber. The flexible polymer layer may include a tension relief zone that overlies or underlies the internal support.

In embodiments in which the method includes compressing and/or decompressing each of multiple spaced apart locations of the flexible polymer layer, the gas chamber may include an electrical contact and/or electrical lead(s) each disposed within the gas chamber and associated with a respective spaced apart location to sense the compression and/or decompression state of one of the spaced apart locations independently of sensing the compression and/or decompression state of the other spaced apart locations.

In embodiments, a method of operating any of the foregoing microfluidic devices includes compressing the gas chamber thereby expelling gas within the microfluidic network from the input port and increasing a width of the tension relief zone along a dimension parallel to the major plane of the strip. In embodiments, the method further includes applying a liquid sample to the input port of the substrate; and decompressing the chamber thereby reducing a pressure of the gas within the microfluidic network and drawing the liquid sample along the microfluidic network toward the chamber and decreasing a width of the tension relief zone along the dimension parallel to the major plane of the strip.

In embodiments, a generally planar medical diagnostic strip for use in detecting the presence of a target in a biological sample includes: (i) a microfluidic network comprising an input port and a gas chamber; and (ii) a polymer layer overlying the microfluidic network. The gas chamber includes internal side walls defining at least in part perimeter thereof. The polymer layer includes one or more tension relief zones, e.g., slits, extending at least 90% through the polymer layer, e.g., at least 95% through the polymer layer or entirely through the polymer layer, along an axis oriented perpendicular to a major plane of the strip. The one or more tension relief zones, e.g., slits, may be disposed adjacent the perimeter of the gas filed chamber as defined by the internal side walls thereof, e.g., within about 2 mm, without about 1.5 mm, within about 1.0 mm, within about 0.75 mm, or within about 0.5 mm of the perimeter of the chamber, along an axis parallel to the major plane of the strip. The at least one tension relief zone may have an aggregate length of at least about 50%, at least about 60%, at least about 70%, or at least about 80%, of the length of the perimeter as defined by the internal side walls. The strip may have a maximum thickness of about 1000 μm or less, about 750 μm or less, about 500 μm or less, or about 400 μm of less along the axis oriented perpendicular to the major plane of the strip.

In embodiments, a generally planar medical diagnostic strip for use in detecting the presence of a target in a biological sample, the strip comprising a microfluidic network includes: (i) an input port, a gas chamber, and at least one channel extending between the input port and the chamber and (ii) a polymer layer overlying or underlying the chamber and at least a portion of the channel. The gas chamber includes internal side walls defining a perimeter thereof. The polymer layer may include one or more tension relief zones, e.g., grooves, extending at least 90% through the polymer layer, e.g., at least 95% through the polymer layer or entirely through the polymer layer, along an axis oriented perpendicular to a major plane of the strip. The one or more tension relief zones, e.g., slits or grooves, may be disposed adjacent the perimeter of the chamber, e.g., within about 2 mm, without about 1.5 mm, within about 1.0 mm, within about 0.75 mm, or within about 0.5 mm of the perimeter p1 of the chamber, along an axis parallel to the major plane of the strip. The one or more tension relief zones, e.g., grooves, may have an aggregate length of at least about 20%, at least about 30%, at least about 40%, at least about 45%, at least about 50%, at least about 55%, at least about 60%, at least about 65%, or at least about 70% of the perimeter (p1). The strip may have a maximum thickness of about 1000 μm or less, about 750 μm or less, about 500 μm or less, about 400 μm of less, or about 350 μm or less along the axis oriented perpendicular to the major plane of the strip.

In embodiments, a medical diagnostic strip for use in detecting the presence of a target in a biological sample includes: a first generally planar substrate portion comprising a first generally planar major surface including a first portion having a first thickness along an axis perpendicular to a major plane of the first generally planar substrate portion and a recessed portion having a second thickness along the axis perpendicular to a major plane of the first generally planar substrate portion, the second thickness being smaller than the first thickness; and a second generally planar substrate including (i) a first generally planar major surface comprising a contact portion secured to the first portion of the first generally planar substrate portion and an opposing portion opposing the recessed portion of the first generally planar substrate portion, the opposing portion and the recessed portion defining a microfluidic network therebetween and (ii) a first tension relief zone, e.g., slit and/or a groove, extending through the contact portion along the axis perpendicular to a major plane of the first generally planar substrate portion and disposed adjacent the opposing portion.

In embodiments, a method of manufacturing a microfluidic device, e.g., a microfluidic strip, includes (i) forming a generally planar substrate comprising a contact surface portion and a microfluidic network portion (ii) securing a contact surface portion of a flexible polymer layer to the contact surface portion of the generally planar substrate such that the microfluidic network portion of the generally planar substrate and a microfluidic network surface portion of the flexible polymer layer form a microfluidic network therebetween, and (iii) prior to, concurrently with, and/or after the step of securing, forming at least one tension relief zone in the flexible polymer layer extending at least partially therethrough, the at least one tension relief zone being disposed within the contact surface portion of the flexible polymer layer.

In embodiments, the contact surface portion of the generally planar substrate is an adhesive surface. The step of forming the at least one tension relief zone may be performed by laser ablation. The at least one tension relief zone may extend at least partially through or entirely through the thickness of the flexible polymer layer. The tension relief zone, microfluidic device (including microfluidic network therein), and polymer layer may have any of the features (e.g., width, thickness, or length), as disclosed in the method of manipulating a liquid disposed within a microfluidic network of a microfluidic device.

In embodiments, a microfluidic device includes a substrate including therein a microfluidic network, the microfluidic network including a gas chamber. The gas chamber includes a first wall and a second wall disposed in opposition to the first wall. At least one of the first and second walls of the gas chamber, at each of a plurality of spaced-apart locations that is in gaseous communication with the other spaced apart locations within the gas chamber is compressible from a first state in which the first and second walls are spaced apart within the gas chamber by a first distance and second state in which the first and second walls are spaced apart within the gas chamber by a second distance smaller than the first distance. The distance spacing the first and second walls apart may be determined along an axis perpendicular to a major plane of the microfluidic device.

The microfluidic device further includes, operatively associated with each of the spaced apart locations: a respective first electrically conductive element and a respective second electrically conductive element. An electrical signal associated with the first and second electrically conductive elements, e.g., a conductivity between the respective first and second electrically conductive elements, associated with each spaced apart location is detectably different in the compressed state and the uncompressed state of such spaced apart location. Using the electrical signals, the compression state of each of the first and second walls associated with each of the respective spaced apart locations can be detected independently of the compression state of the other spaced apart locations.

In embodiments, the microfluidic network includes a sample input port and the gas chamber includes a single outlet in gaseous communication with the sample input port. The microfluidic network may include a reagent zone comprising one or more reagents, which may be in a dry or lyophilized state, configured to bind to a target in a biological sample. Each of the one or more reagents may be disposed in a portion of the microfluidic network located intermediate to the sample input port and the out of the gas chamber and in gaseous communication therewith. The one or more reagents may be configured to bind a target that is indicative of the presence of a (i) pathogen or (ii) a cardiometabolic disorder or condition in a liquid sample applied to the sample input port. The one or more reagents may include a detectable label, e.g., a fluorescent or electrochemically detectable label. Alternatively, or in combination, the reagent may include a reagent configured to reduce a coagulation of a blood sample, e.g., lithium heparin, and/or a reagent configured to lyse or aggregate cells present in a liquid sample.

The wall(s) that is (are) compressible is compressible by the application of a force to an external surface of the wall, e.g., a respective force acting perpendicular to the major plane of the microfluidic device at each of the spaced apart locations. In embodiments, the first state is an operatively uncompressed state, e.g., a relaxed state, in which the wall(s) are not subjected to forces tending to compress the wall(s). In the operatively uncompressed state, the internal surfaces of the opposing first and second walls are typically planar and parallel to one another. In the embodiments, the second state is an operatively fully compressed state in which an inner surface of one of the first and second walls or an electrically conductive element disposed thereon contacts an opposing inner surface of the other of the first and second walls and/or an electrically conductive element disposed thereon.

In embodiments, the first distance within the gas chamber at each of the spaced apart locations between the first and second walls in the uncompressed state is about 500 μm or less, about 400 μm or less, about 300 μm or less, about 200 μm or less, about 150 μm or less, about 125 μm or less, or about 100 μm or less. The first distance within the gas chamber at each of the spaced apart locations between the first and second walls in the uncompressed state is about 25 μm or more, about 50 μm or more, about 75 μm or more, about 100 μm or more, about 125 μm or more, or about 150 μm or more. For example, the first distance may be between about 80 and 130 μm, e.g., about 115 μm.

In embodiments, the second distance within the gas chamber at each of the spaced apart locations between the first and second walls in the compressed state is about 10 μm or less, about 7.5 μm or less, about 5 μm or less, about 2.5 μm or less or essentially zero. For example, first and second walls at each of the spaced apart locations may in direct contact within the gas chamber in the compressed state. The first and second electrically conductive elements associated with each respective spaced apart location may be in electrical communication with one another, e.g., in direct or indirect electrical communication, when the spaced apart location is in one of the compressed or uncompressed states but not the other of the compressed or compressed states.

In embodiments, one of the first and second walls at each of the spaced apart locations includes a respective electrically conductive member, e.g., disposed on an inner surface of the first or second wall, and the other of the first and second walls at each of the spaced apart locations includes the first and second electrically conductive elements associated with such spaced apart location, e.g., disposed on an inner surface of such other of the first and second walls. When such spaced apart location is in the compressed state, the first and second electrically conductive elements associated with such spaced apart location are in indirect electrical communication via the respective electrically conductive member associated with such spaced apart location.

In embodiments of the microfluidic device, each of the spaced apart locations is partially separated within the interior the gas chamber from the other spaced apart locations by at least one internal side wall extending between the first and second walls. In embodiments, the internal separating side walls have a width in a dimension parallel to a major plane of the microfluidic device of at least about 500 μm, at least about 750 μm or at least about 1000 μm. The width of the internal separating side walls may be about 2000 μm or less, about 1500 μm or less, or about 1250 μm or less. For example, the width of the internal separating side walls may be about 1000 μm. In embodiments, the internal separating side walls have a length in a dimension perpendicular to the width and parallel to the major plane of the microfluidic device of at least about 5 mm, at least about 7.5 mm, or at least about 10 mm. The length of the internal separating side walls may about 15 mm or less, or about 12.5 mm or less. For example, the length of the internal separating side walls may be about 11 mm. In embodiments, each of the spaced apart locations has a width defined by the spacing between adjacent internal separating side walls in the same dimension as the width of the sidewalls themselves. The spacing between adjacent internal separating side walls may be about 3 mm or more, about 3.5 mm or more, or about 4 mm or more. The spacing between adjacent internal separating side walls may be about 7.5 mm or less, about 6 mm or less, or about 4 mm or less. In embodiments, each of the spaced apart locations has a length defined by the length of the internal side walls.

In embodiments of the microfluidic device, the at least one of the first and second walls at each of the spaced apart locations is independently compressible from the uncompressed state to the compressed state without substantially compressing the at least one of the first and second walls of the other of the spaced apart locations. The at least one of the first and second walls at each of the spaced apart locations may be independently compressible from the uncompressed state to the compressed state without substantially reducing the distance within the gas chamber by which the first and second walls at the other spaced apart locations are spaced apart from one another. The at least one of the first and second walls at each of the spaced apart locations may be independently compressible from the uncompressed state to the compressed state while at the same time the distance within the gas chamber by which the first and second walls at the other spaced apart locations are spaced apart from one another remains without about 90%, within about 95%, or within about 97.5% of the first distance. The at least one of the first and second walls at each of the spaced apart locations may be independently compressible from the uncompressed state to the compressed state while at the same time the distance within the gas chamber by which the first and second walls at the other spaced apart locations are spaced apart from one another remains essentially the same as, or the same as, the first distance.

In embodiments, the microfluidic device includes a plurality of electrical contacts, wherein each electrical contact is in electrical communication with a respective first or second electrically conductive element. When the microfluidic device is operatively inserted into a diagnostic instrument capable of operating the microfluidic device, the electrical contacts of the microfluidic device contact electrical contacts of the diagnostic instrument such that the diagnostic instrument is capable of detecting the electrical signal associated with each of the corresponding electrically conductive elements. The electrical contacts of the microfluidic device may be disposed at or adjacent a periphery of the microfluidic device.

In embodiments, the microfluidic device includes a first electrode that is (i) disposed within the microfluidic network at a location other than the gas chamber and (ii) in electrical communication with at least one of the electrically conductive elements associated with one of the spaced apart locations. In embodiments, the microfluidic device includes a second electrode that is (i) disposed within the microfluidic network at a location other than the gas chamber or the location of the first electrode and (ii) in electrical communication with at least one of the electrically conductive elements associated with one of the spaced apart locations, wherein the first and second electrodes are in electrical communication with different electrically conductive elements. In embodiments, the microfluidic network of the microfluidic device includes a third electrode that is (i) disposed within the microfluidic network at a location other than the gas chamber or the locations of the first or second electrodes and (ii) in electrical communication with at least one of the electrically conductive elements associated with one of the spaced apart locations, wherein the first, second and third electrodes are in electrical communication with different electrically conductive elements.

In use, at least one, e.g., all, of the first, second, and third electrodes may perform a liquid sensing function. An electrical signal received or generated by a particular first, second, or third electrodes is indicative of the presence or absence of a liquid, e.g., a liquid sample, at the location of the electrode within the microfluidic network. In embodiments, location within the microfluidic network of the first electrode is a first electrode distance along the microfluidic network from the input port, the location within the microfluidic network of the second electrode is a second electrode distance along the microfluidic network from the input port, and the location of the third electrode within the microfluidic network is a third electrode distance along the microfluidic network from the input port, wherein the first electrode distance is less than the second electrode distance which is less than the third electrode distance. In embodiments, the respective locations within the microfluidic network of at least two of the first, second, and third electrodes are spaced apart by a portion of the microfluidic channel comprising any of the reagents disclosed herein. In embodiments, the location of the first electrode may be spaced apart from the input port by a region of the microfluidic device including any of the reagents disclosed herein.

In embodiments of the microfluidic device, the substrate is a microfluidic strip, e.g., a flexible microfluidic strip. In embodiments, the substrate has a maximum thickness along an axis perpendicular to a major plane of the substrate of about 2000 μm or less, about 1500 μm or less, about 1000 μm or less, about 750 μm or less, about 500 μm or less, or about 400 μm or less. In embodiments, the substrate has a maximum thickness along an axis perpendicular to a major plane of the substrate of at least about 50 μm, at least about 150 μm, at least about 250 μm, or at least about 300 μm, e.g., a maximum thickness of about 325 μm.

In embodiments of the microfluidic device, when the first and second walls at each of the spaced apart locations are in the uncompressed state, a ratio of a total volume of gas occupying the gas chamber to a total cross-sectional area in a plane perpendicular to a major plane of the substrate of an outlet of the gas chamber to the microfluidic network is at least about 15, at least about 20, at least about 25, at least about 30, at least about 35, at least about 40, at least about 50, at least about 60, or at least about 75. When the first and second walls at each of the spaced apart locations are in the uncompressed state, a ratio of a total volume of gas occupying the gas chamber to a total cross-sectional area in a plane perpendicular to a major plane of the substrate of an outlet of the gas chamber to the microfluidic network may be about 150 or less, about 125 or less, about 100 or less, about 90 or less, or about 80 or less.

In embodiments of the microfluidic device, when the microfluidic device is in use, the microfluidic network comprises an amount of a liquid sample disposed within the microfluidic network, the liquid of the sample liquid and a gas in gaseous communication with the gas of the gas chamber form a liquid-gas interface within the microfluidic network, and a ratio of a total volume of gas occupying the gas chamber to a total cross-sectional area in a plane perpendicular to a major plane of the substrate of the microfluidic network at the location occupied by the gas-liquid interface is at least about 15, at least about 20, at least about 25, at least about 30, at least about 35, at least about 40, at least about 50, at least about 60, or at least about 75. A ratio of a total volume of gas occupying the gas chamber to a total cross-sectional area in a plane perpendicular to a major plane of the substrate of the microfluidic network at the location occupied by the gas-liquid interface may be about 150 or less, about 125 or less, about 100 or less, about 90 or less, or about 80 or less.

In embodiments, a method of using the microfluidic device includes compressing at least one of the first and second walls at each of the plurality of spaced apart locations; and detecting a respective electrical signal from at least one of the respective first and second electrically conductive elements operatively associated with each of the spaced locations, wherein each electrical signal indicates that the first and second walls associated with the respective spaced apart location are in the compressed state.

The method of using the microfluidic device may further include following the step of detecting, decompressing the at least one of the first and second walls at each of the plurality of locations at least until determining that the electrical signal indicates that the first and second walls associated with each of the respective spaced apart locations are no longer in the operatively fully compressed state. After the step of determining the electrical signal indicates that the first and second walls are no longer in the operatively fully compressed state, the decompressing may be stopped with the walls in a partially compressed state.

After the step of decompressing, the method may further include introducing a liquid sample into the microfluidic network of the microfluidic device; forming a liquid-gas interface within the microfluidic network wherein the liquid of the liquid-gas interface is the sample liquid introduced to the microfluidic network and the gas of the liquid-gas interface is in gaseous communication with the gas of the gas chamber; allowing the liquid sample to flow along a portion of the microfluidic network of the microfluidic device via capillary action; stopping the flow of the liquid sample along the microfluidic network; and after the stopping the flow of the liquid sample, simultaneously further decompressing the first and second walls associated with each of the plurality of spaced apart locations thereby reducing a pressure of the gas of the liquid-gas interface and moving the liquid-gas interface along the microfluidic network toward the gas chamber.

The method may further including moving the liquid-gas interface along the microfluidic network toward the gas chamber until the liquid of the liquid-gas interface contacts one of the first, second, or third electrodes disposed within the microfluidic network, detecting an electrical signal indicative of the contact of the liquid and the first, second, or third electrodes, and stopping the decompressing the first and second walls of each of the plurality of spaced apart locations, thereby stopping the movement of the liquid-gas interface toward the gas chamber.

The method of using the microfluidic device may further include synchronously oscillating the distance within the gas chamber by which the respective first and second walls are spaced apart at each of the plurality of spaced apart locations at a frequency of at least about 100 Hz, at least about 200 Hz, at least about 300 Hz, at least about 400 Hz, at least about 500 Hz, at least about 600 Hz, at least about 700 Hz. The frequency of oscillation may be an acoustic frequency. The frequency of oscillation may be about 2000 Hz or less, about 1750 Hz or less, about 1500 Hz or less, about 1250 Hz or less, or about 1000 Hz or less. The oscillating the distance spacing apart the respective first and second walls may include oscillating the distance spacing apart the respective first and second walls along an axis perpendicular to a major plane of the substrate. The oscillating the distance spacing apart the respective first and second walls may include oscillating the distance spacing apart the respective first and second walls along an axis perpendicular to a major plane of the substrate by at least about 2.5 μm, at least about 5 μm, at least about 7.5 μm, or at least about 10 μm. The oscillating the distance spacing apart the respective first and second walls may include oscillating the distance spacing apart the respective first and second walls along an axis perpendicular to a major plane of the substrate by about 50 μm or less, about 40 μm or less, or about 30 μm or less.

The method may include introducing a liquid sample into the microfluidic network of the microfluidic device; forming a liquid-gas interface within the microfluidic network wherein the liquid of the liquid-gas interface is the sample liquid and the gas of the liquid-gas interface is in gaseous communication with the gas of the gas chamber and wherein the oscillating the distance spacing apart the respective first and second walls oscillates a pressure of the gas of the liquid-gas interface. The method may include contacting, within the microfluidic network, the liquid sample and any of the one or more reagents disclosed herein, wherein the oscillating the gas of the liquid-gas interface induces mixing of the liquid sample and the one or more reagents.

In embodiments of the method of using the microfluidic device, each of the spaced apart locations may be partially separated within the interior the gas chamber from the other spaced apart locations by at least one internal separating side wall extending between the first and second walls. The internal separating side walls may have any of the dimensions or other features of any of the other separating side walls disclosed herein.

The oscillating may include oscillating a total volume of gas occupying the gas chamber having a ratio to a total cross-sectional area in a plane perpendicular to a major plane of the substrate of an outlet of the gas chamber to the microfluidic network of at least about 15, at least about 20, at least about 25, at least about 30, at least about 35, at least about 40, at least about 50, at least about 60, or at least about 75. The method may include oscillating a total volume of gas occupying the gas chamber having a ratio to a total cross-sectional area in a plane perpendicular to a major plane of the substrate of an outlet of the gas chamber to the microfluidic network of about 150 or less, about 125 or less, about 100 or less, about 90 or less, or about 80 or less. The oscillating may include oscillating a total volume of gas occupying the gas chamber having a ratio to a total cross-sectional area of the microfluidic network in a plane perpendicular to a major plane of the substrate at the location occupied by the gas-liquid interface of at least about 15, at least about 20, at least about 25, at least about 30, at least about 35, at least about 40, at least about 50, at least about 60, or at least about 75. The oscillating may include oscillating a total volume of gas occupying the gas chamber having a ratio to a total cross-sectional area of the microfluidic network in a plane perpendicular to a major plane of the substrate at the location occupied by the gas-liquid interface of about 150 or less, about 125 or less, about 100 or less, about 90 or less, or about 80 or less.

In embodiments, a method of mixing a reagent and a liquid sample within a microfluidic network of a microfluidic device includes synchronously oscillating each of a plurality of spaced-apart locations of a wall of a gas chamber of the microfluidic device wherein the gas of the gas chamber is in gaseous communication with a liquid-gas interface of the liquid sample. The oscillating may be performed at one or more acoustic frequencies as disclosed herein. During the step of synchronously oscillating, the gas of the gas chamber may be spaced apart from a sample input port of the microfluidic device by the liquid-gas interface. The step of oscillating may be performed by contacting a respective outer surface of the wall of each of the spaced apart locations using a respective mechanical actuator. Each of the respective mechanical actuators may contact an area of the outer surface of each respective portion of the wall of between about 1 mm² and 12 mm², of between about 3 mm² and 10 mm², of between about 4 mm² and 8 mm², or between about 5 mm² and 7 mm², e.g., about 6 mm². The total area of contact between the actuators and the gas chamber is given by the sum of the area of each actuator in contact with the gas chamber.

In embodiments, a method of moving a liquid within a microfluidic network of a microfluidic device includes compressing each of multiple locations of a gas chamber of the microfluidic network thereby expelling at least some of the gas from within the microfluidic network from a sample input port of the microfluidic device. A liquid sample is introduced to the sample input port of the microfluidic device. The liquid of the liquid sample and gas remaining within the microfluidic network form a liquid-gas interface disposed therein between the sample input port and the gas chamber. The liquid sample may move along the microfluidic network, e.g., by capillary action, until the liquid-gas interface reaches a capillary stop within the microfluidic network, e.g., a capillary stop associated with a vent providing egress for gas within the microfluidic network to exit the microfluidic network. The method further includes decompressing each of the multiple locations of the gas chamber, thereby reducing a pressure of the gas of the liquid-gas interface thereby drawing the sample liquid along, e.g., further along the microfluidic network from the location of the vent, the microfluidic network toward the gas chamber.

In embodiments, the step of compressing includes receiving a respective electrical signal associated with each of the spaced apart locations, each electrical signal being indicative of the compression state of a respective spaced apart location. For example, each of the spaced apart locations may include a one or more electrically conductive elements and/or an electrically conductive member as disclosed herein.

In embodiments, the step of decompressing includes increasing a respective spacing between an inner surface of a first wall and an inner surface of a second wall associated with each spaced apart location by a total amount X. During the step of increasing the respective spacing, the method includes further oscillating the respective spacing between the first internal wall surface and the second internal wall surface associated with each spaced apart location by an amount Y, where X>Y. The oscillating may be performed at an acoustic frequency, e.g., at any of the acoustic frequencies disclosed herein. The step of oscillating the respective spacing between the first internal wall surface and the second internal wall surface associated with each spaced apart locations may be performed synchronously with the other of the spaced apart locations.

In embodiments, the step of compressing and/or the step of oscillating is performed by compressing and/or oscillating an outer surface of a respective portion of a wall overlying or underlying each of the multiple locations of the gas chamber of the microfluidic network using a respective mechanical actuator. In embodiments, each of the respective mechanical actuators contacts an area of the outer surface of each respective portion of the wall of between about 1 mm² and 12 mm², of between about 3 mm² and 10 mm², of between about 4 mm² and 8 mm², or between about 5 mm² and 7 mm², e.g., about 6 mm².

A gas chamber may also be referred to as a gas bladder. In any of the embodiments, a tension relief zone may be linear, arcuate, or combination thereof. In any of the embodiments, a perimeter p1 of a gas chamber as defined by the side walls thereof may be or include arcuate portions in alternative to or in combination with linear portions. In any of the embodiments, a liquid sample may be any of the liquid samples disclosed in the '325 application. In a gas chamber, at least some gas resides within the chamber when the gas chamber is in an uncompressed state. In a fully compressed state, at least some, e.g., most, of such gas may be expelled from the gas chamber.

### BRIEF DESCRIPTION OF THE FIGURES

FIG. 1 is a perspective view of a diagnostic system of the invention including a diagnostic reader and a microfluidic strip;

FIG. 2 is a top view of the microfluidic strip of FIG. 1;

FIGS. 3A and 3B together are an exploded perspective view of the microfluidic strip of FIG. 1 with FIG. 3A showing the upper substrate (flexible polymer film) of the microfluidic strip and FIG. 3B showing the lower substrate (e.g., flexible polymer film) and adhesive layer of the microfluidic strip of FIG. 1;

FIG. 4 is a cross-sectional view of the microfluidic strip of FIG. 2 taken along a line a4 passing through gas chambers of the microfluidic strip;

FIG. 5 is a magnified view of a portion of the cross-sectional view of the microfluidic strip as indicated in FIG. 4;

FIG. 6 is a top view of a microfluidic strip of the invention, the microfluidic strip having a gas chamber with multiple spaced apart locations capable of being compressed, decompressed, and/or oscillated by the diagnostic reader of FIG. 1 to achieve the movement of liquid sample within the microfluidic strip and/or the mixing of liquid sample with reagents within the microfluidic strip; and

FIG. 7 is a top view of the gas chamber of the microfluidic strip of FIG. 6 as defined by internal side walls thereof, with electrodes and other features thereof removed for clarity.

FIG. 8 is another top view of a microfluidic strip of an invention described herein, the microfluidic strip having a gas chamber with multiple spaced apart locations each in gaseous communication with the others and capable of being compressed, decompressed, and/or oscillated by the diagnostic reader of FIG. 1 to achieve the movement of liquid sample within the microfluidic strip and/or the mixing of liquid sample with reagents within the microfluidic strip.

FIG. 9 is yet another top view of a microfluidic strip of an invention described herein, the microfluidic strip having multiple gas chambers each in fluidic communication with a corresponding analysis channel, wherein each section of an upper wall overlying a respective gas chamber is separated by a tension relief zone, and capable of being compressed, decompressed, and/or oscillated by the diagnostic reader of FIG. 1 to achieve the movement of liquid sample within the corresponding analysis channel and/or the mixing of liquid sample with reagents within the corresponding analysis channel.

FIG. 10 is yet another top view of a microfluidic strip of an invention described herein, the microfluidic strip having multiple gas chambers each in fluidic communication with a corresponding analysis channel, wherein each section of an upper wall overlying a respective gas chamber is separated by a tension relief zone, and capable of being compressed, decompressed, and/or oscillated by the diagnostic reader of FIG. 1 to achieve the movement of liquid sample within the corresponding analysis channel and/or the mixing of liquid sample with reagents within the corresponding analysis channel.

### DETAILED DESCRIPTION

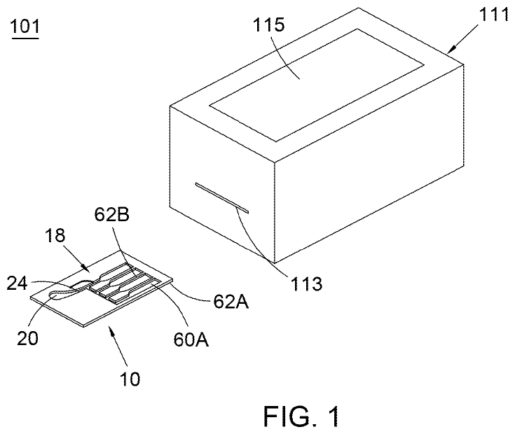

With reference to FIG. 1, a diagnostic system 101 includes a microfluidic strip 10 and a diagnostic reader 111. Reader 111 operates strip 10 to determine the presence and/or amount of at least one target (e.g., a biomolecule such as a protein) present in a sample liquid applied to strip 10. For example, strip 10 may be configured and operated to determine any of the targets disclosed in the '325 application. Reader 111 includes an input port 113, which receives microfluidic strip 10, and a touchscreen 115 by which a user can enter and receive information relevant to the operation of reader 111 and the determination of the target. Reader 111 may include features related to the operation of strip 10 including a magnetic field generator, an optical detection system, a flow controller, and contacts to receive and/or supply electrical signals to electrical components of strip 10 as disclosed in the '325 application.

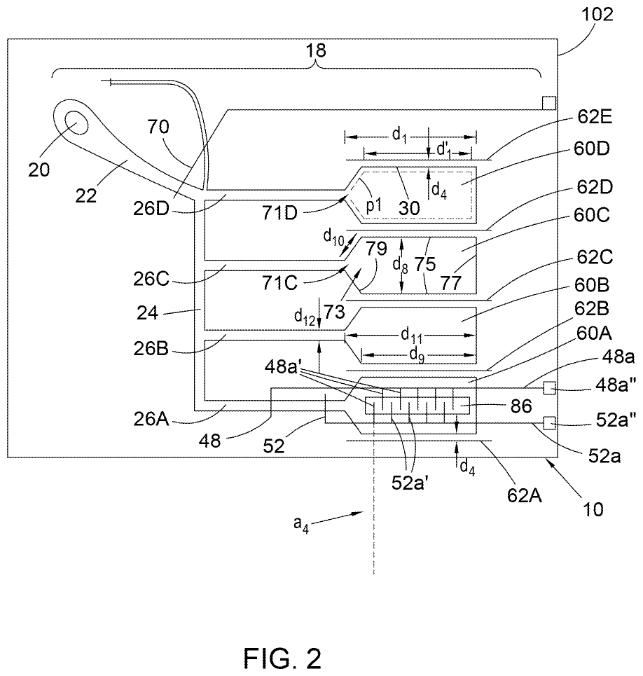

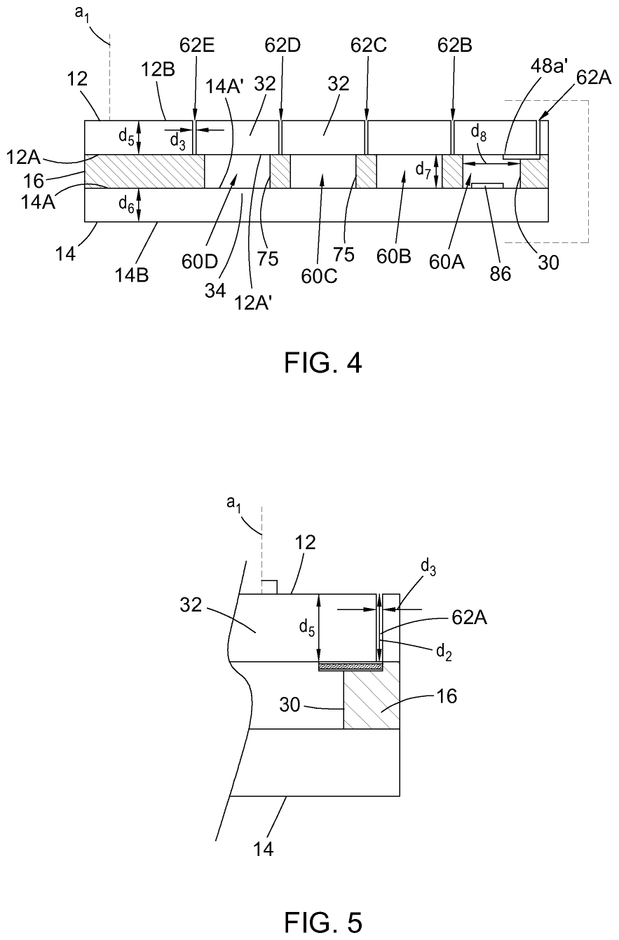

With reference to FIGS. 2-5, strip 10 includes an upper substrate 12 and a lower substrate 14. Upper substrate 12 is a flexible polymer layer, e.g., a flexible polymer sheet, having a thickness d5 between about 50 and 500 μm, between about 50 and 400 μm, between about 50 and 300 μm, between about 50 and 250 μm, between about 50 and 200 μm, between about 50 and 150 μm, or between about 50 and 125 μm, of about 100 μm along an axis a1 perpendicular to a major plane of the substrate. Upper substrate 12 includes a plurality of tension relief zones 62A-62E each operatively associated with one or two gas chambers 60A-60D of microfluidic network 18. The tension relief zones 62A-62B are configured to reduce a tension experienced by the upper wall 32 (of the upper substrate 12) overlying each gas chamber when the upper wall is compressed as compared to the tension that would be experienced by the upper wall 32 when the upper wall is compressed in the absence of the one or more tension relief zones. As an alternative, or in combination, with the function of reducing tension experienced by the upper wall 32 during compression, the tension relief zones may also equalize a tension experienced by the upper wall overlying each gas chamber as compared to the tension experienced by the upper wall overlying the other gas chambers upon compression thereof. Tension relief zones 62A-62E are discussed further below.

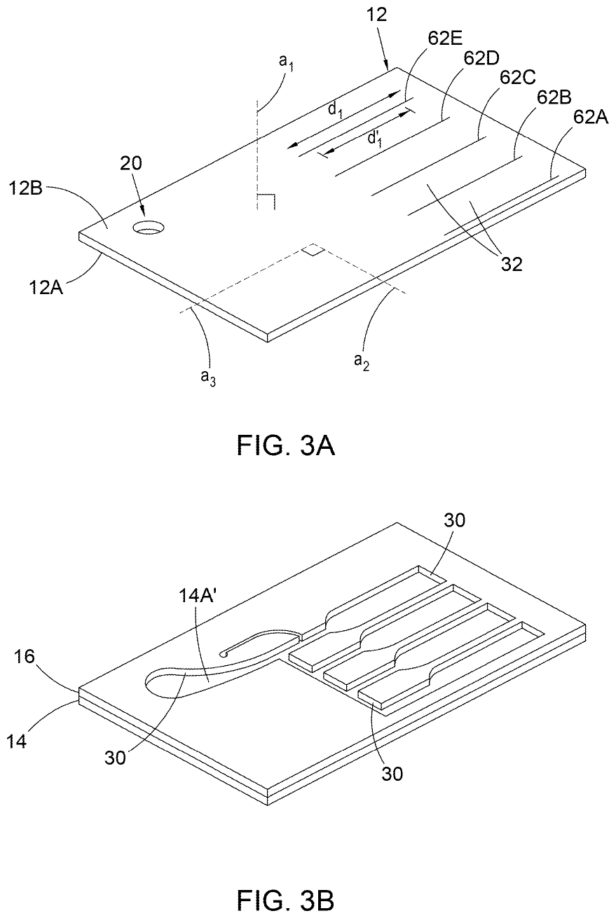

Lower substrate 14 is a flexible polymer layer, e.g., a flexible polymer sheet, having a thickness d6 between about 50 and 500 μm, between about 50 and 400 μm, between about 50 and 300 μm, between about 50 and 250 μm, between about 50 and 200 μm, between about 50 and 150 μm, or between about 50 and 125 μm, of about 100 μm along axis a1. For example, upper substrate 12 and/or lower substrate 14 may be a flexible polyester sheet having a thickness d5=d6=100 μm along axis a1. A lower surface 12a of upper substrate 12 and an upper surface 14a of lower substrate 14 are adhered in opposition by an adhesive layer 16. Adhesive layer 16 has a thickness d7 between about 50 and 500 μm, between about 50 and 400 μm, between about 50 and 300 μm, between about 50 and 250 μm, between about 50 and 200 μm, between about 50 and 150 μm, or between about 50 and 125 μm, of about 110 μm along axis a1. Adhesive layer 16 occupies less than all of the area of surfaces 12a, 14a between upper and lower substrates 12,14 to define a microfluidic channel network 18 therebetween. A maximum thickness of strip 10 along axis a1 is given by the sum of the thicknesses of lower substrate 14 (e.g., 100 μm), adhesive layer 16 (e.g., 110 μm), and upper substrate 12 (e.g., 100 μm), thereby totaling to about 310 μm for example. As evident from FIGS. 3A and 3B, a minimum thickness of strip 10 along axis a1 is the thickness of lower substrate 14 (100 μm) and is located at input port 20 where adhesive layer 16 and upper substrate 12 have been removed to permit the introduction of sample liquid to microfluidic network 18.

Microfluidic channel network 18 has a sample application zone 20, a common supply channel 22, a branch channel 24, and four analysis channels 26A-26D. Microfluidic channel network 18 is in part defined by side walls 30 of adhesive layer 16, an upper wall 32 defined by those portions of upper substrate 12 unoccupied by adhesive layer 16, e.g., overlying absent portions of adhesive layer 16, and a lower wall 34 defined by those portions of lower substrate 14 unoccupied by adhesive layer 16, e.g., underlying the absent portions of adhesive layer 16. Upper wall 32 has an inner surface 12a′ defined by those portions of surface 12a unoccupied by, e.g., exposed by the absent portions of, adhesive layer 16. Lower wall 34 has an inner surface 14a′ defined by those portions of surface 14a unoccupied by, e.g., exposed by the absent portions of, adhesive layer 16. Upper substrate 12 has an outer (upper) surface 12b and lower substrate 14 has an outer (lower) surface 14b.

Each analysis channel 26A-26D is arranged and configured to facilitate the determination of the presence and/or amount of the target present in the sample liquid. Proceeding distally from branch channel 24 along a longitudinal axis of each analysis channel 26A-26D, each analysis channel may include analysis channel features described in the '325 application including a vent, a capillary stop, one or more reagent zones, side cavities, fill electrodes one or more reagent zones, a plurality of side cavities, a first fill electrode 48, a second fill electrode 52, a detection zone, a spacing channel, and a gas chamber 60A-60D. Each gas chamber 60A-60D includes an opening placing the gas chamber in gaseous communication with the corresponding analysis channel 26A-26D (see, e.g., FIG. 2 showing openings 71C and 71D, by which gas chambers 60C and 60D are in gaseous communication with respective analysis channels 26C and 26D. Analysis channels 26A-26D have a width d12 between about 100 μm to about 1000 μm, between about 200 μm to about 800 μm, between about 300 μm to about 700 μm, or of about 600 μm along axis a2 parallel to the major plane of strip 10.

With reference to FIGS. 2, 3A and 3B, each gas chamber 60A-60D has a distal gas chamber internal side wall 77 defining a gas chamber width d8 along a dimension parallel to an axis a2, two opposing major internal gas chamber side walls 75 having a length d9 along a dimension parallel to an axis a3, a chamfer portion 73 with chamfer internal side walls 79, and a total length d11 parallel to an axis a3. Each gas chamber has a perimeter p1 defined by internal side walls 75, 77, and 79 within each gas chamber. For example, perimeter p1 of gas chambers 60A-60D is 31 mm given by the sum of side wall dimensions d8 (distal side wall 77 having a width of 4 mm), d9 (twice the length of each major side wall 75 or 2×11 mm), and d10 (twice the length of each chamfer side wall 79 or 2×2.5 mm). The perimeter p1 of each gas chamber may be from about 10 mm to about 10 cm, from about 15 mm to about 5 cm, from about 20 mm to about 3 cm, from about 25 mm to about 2 cm, or from about 30 mm to about 1 cm. The opening of each gas chamber (e.g., respective openings 71C, 71D of gas chambers 60C, 60D) to the corresponding analysis chamber is not included in the determining the perimeter p1 of the gas chamber. The opening of each gas chamber has a width of about 600 μm.

Each tension relief zone 62A-62E is a laser ablated slit extending entirely through the full thickness of upper substrate 12 along axis a1 that is perpendicular to the major plane of the microfluidic device. Tension relief zones 62A-62E have a total length d1 between about 1 mm to about 50 mm, between about 3 mm to about 40 mm, between about 5 mm to about 30 mm, between about 10 mm to about 20 mm, of about 13 mm along an axis a3 parallel to the major plane of the microfluidic device. Tension relief zones 62A-62E have a height d2 of about 100 μm along axis a1, which height corresponds to the full thickness of upper substrate 12. Although tension relief zones 62A-62E are shown as extending through upper substrate 12, such tension relief zones may have a height of less than the full thickness of the polymer layer. For example, at least a portion of the tension relief zone(s) may extend through at least about 25%, at least about 50%, at least about 75%, at least about 85%, at least about 95%, essentially all the way through, or entirely through the flexible polymer layer. The portion of the tension relief zone that so extends may include at least about 25%, at least about 50%, at least about 75%, at least about 95%, essentially all, or all of the tension relief zone(s). Tension relief zones 62A-62E have a width d3 between about 10 μm to about 500 μm, between about 25 μm to about 250 μm, between about 50 μm to about 200 μm, of about 150 μm along an axis a2 perpendicular to both axes a1 and a3 and parallel to the major plane of the microfluidic device. A length d1′ from about 5 mm to about 25 mm (e.g., about 11 mm) of each tension relief zone 62A-62E is disposed within a distance d4 from about 100 μm to about 1 mm (e.g., about 500 μm) of internal side walls 75 of microfluidic network 18. For each gas chamber 60A-60D, the total length of tension relief zones 62A-62E that is disposed within distance d4 of the internal side wall 30 of the gas chamber is, with an exemplary length d1′ of 11 mm, 22 mm given by 2×d1′. Accordingly, for each gas chamber 60A-60D, with an exemplary gas chamber perimeter p1 of about 22 mm, the ratio of the total length of tension relief disposed within distance d4 of the side wall of the gas chamber to the perimeter p1 of the gas chamber is 2×d1′/p1=22 mm/31 mm or about 0.70.

Each tension relief zone 62A-62D may be aligned with a side wall d4 of one or more gas chambers. As discussed herein, the length d1 of each tension relief zone may extend beyond a side wall d4 of one or more gas chambers, while a length d1′ of each tension relief zone may correspond to or approximately to a length of a side wall d4. One or more tension relief zones, such as 62B, 62C, and 62D may be aligned with a side wall from two adjacent gas chambers.

As discussed herein, each tension relief zone may include a portion d1′ that is aligned with and corresponds to at least a portion of one or more side walls d4 of a gas chamber. Said portion d1′ of the relief zone may track a shape of a sidewall of a gas chamber, such as being in a straight line. Said portion d1′ may be in any shape or configuration, spanning at least a portion of a sidewall d4. For example, said portion d1′, and in some cases the entire tension relief zone d1, is in a straight line, curved, arcuate, zig-zagged, at an angle (as compared to a longitudinal axis to one or more sidewalls of a gas chamber), or any combination thereof.

In some cases, a separation distance between centers of two sections of the upper wall 32 overlaying corresponding two gas chambers is based on a width of a corresponding tension relief zone therebetween. In some cases, the separation distance between centers varies based on decompression and/or compression of the upper wall 32. For example, compressing one or both of a section of an upper wall 32 overlaying a gas chamber may decrease a width of the tension relief zone, and thereby a separation distance between the centers therebetween, where decompressing may increase said separation distance.

Strip 10 includes electrodes disposed and configured to permit reader 111 to monitor the proper filling of strip 10 with sample liquid, the proper movement of sample liquid within strip 10 and the operation (e.g., the compression state) of each gas chamber 60A-60D. Such electrodes may be arranged and configured as disclosed in the '325 application. For clarity, FIGS. 1-5 illustrate such electrodes only for analysis channel 26a but each of the analysis channels of strip 10 may include such electrodes. In brief, strip 10 includes a supply electrode 70 and fill electrodes 48,52 disposed at spaced apart locations within analysis channel 26a. Supply electrode 70 emits an electrical signal that are received by respective fill electrodes 48,52 when sample liquid occupies the microfluidic network therebetween as disclosed in the '325 application. Each of analysis channel fill electrodes 48,52 is connected via a respective lead 48a, 52a to a respective contact 48a″, 52a″ located adjacent a distal periphery 102 of strip 10. When strip 10 is fully inserted into reader 111, contacts 48a″, 52a″ of leads 48a, 52a engage corresponding contacts (not shown) within reader 111. The engaged contacts permit reader 111 to deliver and/or receive electrical signals to and/or from supply electrode 70 and fill electrodes 48,52. Except as discussed below, corresponding leads 48a, 52a are disposed outside of microfluidic channel network 18 on those portions of upper surface 14a of lower substrate 14 that remain covered by adhesive layer 16.

Portions of lead 48a of first fill electrode 48 and of lead 52a of second fill electrode 52 pass along internal surface 14a′ of gas chamber lower wall 84 and respectively define interposed first and second interposed electrically conductive lead electrodes 48a′ and 52a′. An electrically conductive bridging contact 86 is disposed on internal surface 12a′ of gas chamber upper wall 78 and overlies lead electrodes 48a′, 52a′. When gas chamber upper wall 78 is operatively fully compressed, bridging contact 86 establishes continuity between lead electrodes 48a′, 56a′, which are otherwise are not in direct continuity with one another. Reader 111 delivers and/or receives electrical signals to and/or from lead electrodes 48a′, 52a′ via the same contacts as for fill electrodes 48, 52.

During operation of strip 10, the flow controller of reader 111 compresses and decompresses the upper wall 32 overlying each gas chamber 60A-60D to increase or decrease a pressure of gas therein which is in gaseous communication with a liquid-gas interface of liquid sample within the microfluidic network to move liquid sample with the corresponding analysis channel 26A-26D. For example, the compression/decompression may be performed as disclosed in the '325 application with respect to the use of a piezoelectric actuator having an actuation foot to compress, decompress, and/or oscillate the upper wall overlying reach gas chamber 60A-60D. During operation of strip 10, the flow controller of reader 111 may also oscillate the upper wall 32 overlying each gas chamber 60A-60D to oscillate the pressure of the gas therein to cause mixing of the liquid sample with reagents within the microfluidic network, for example as disclosed in the '325 application. The actions of compressing or decompressing and of oscillating upper wall 32 of each gas chamber may be performed independently or in combination, as disclosed in the '325 application. Accordingly, each section of an upper wall 32 overlaying a corresponding gas chamber 60A-60D may be calibrated independently to obtain a desired tension during compression and/or decompression.

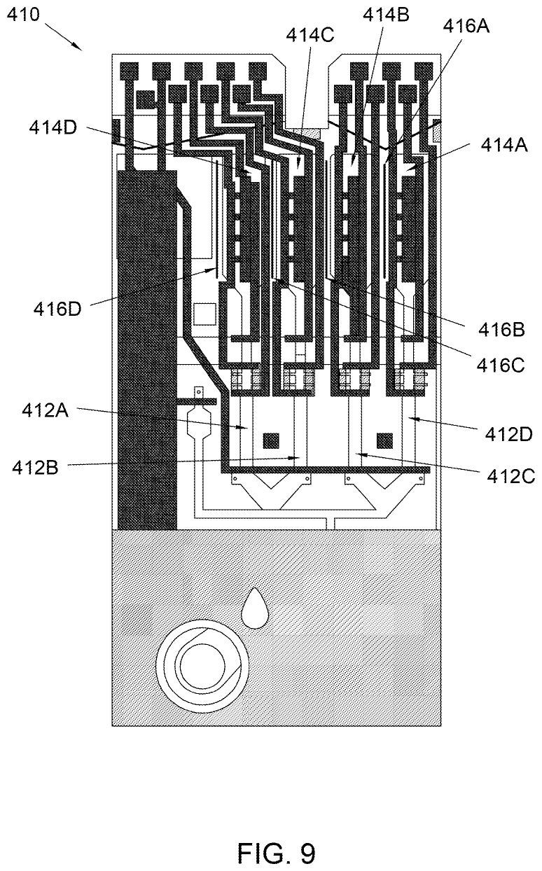

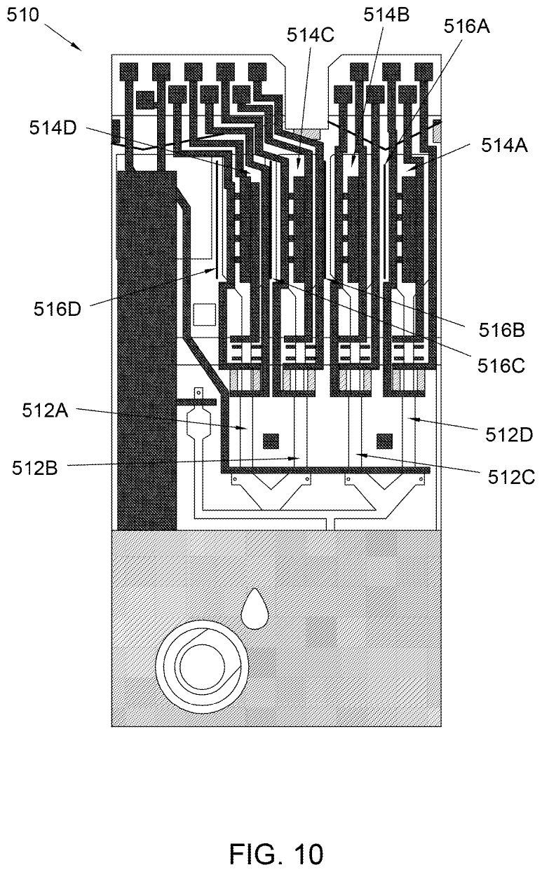

FIGS. 9 and 10 depict exemplary top views of an embodiment of a microfluidic strip 410, 510 having a microfluidic network, each including four analysis channels 412A-D, 512A-D as described herein, and each configured to determine the presence and/or amount of at least one target (e.g., a biomolecule such as a protein) present in a sample liquid applied to strip, such as determining any of the targets disclosed in the '325 application.

In some cases, the strip 410 (FIG. 9) is configured and operated for NT-ProBNP determination. The strip 410 further comprises gas chambers 414A, 414B, 414C, 414D corresponding to a respective analysis channel, similar to strip 10 as described herein. The strip further includes tension relief zones 416A, 416B, 416C, 416D, 416E configured to reduce a tension experienced by the upper wall (of the corresponding upper substrate on the strip 410) overlying each gas chamber when the upper wall is compressed as compared to the tension that would be experienced by the upper wall when the upper wall is compressed in the absence of the one or more tension relief zones. As an alternative, or in combination, with the function of reducing tension experienced by the upper wall during compression, the tension relief zones may also equalize a tension experienced by the upper wall overlying each gas chamber as compared to the tension experienced by the upper wall overlying the other gas chambers upon compression thereof.

In some cases, the strip 510 (FIG. 10) is configured and operated for HbA1c determination. The strip 510 further comprises gas chambers 514A, 514B, 514C, 514D corresponding to a respective analysis channel, similar to strip 10 as described herein. The strip further includes tension relief zones 516A, 516B, 516C, 516D, 516E configured to reduce a tension experienced by the upper wall (of the corresponding upper substrate on the strip 510) overlying each gas chamber when the upper wall is compressed as compared to the tension that would be experienced by the upper wall when the upper wall is compressed in the absence of the one or more tension relief zones. As an alternative, or in combination, with the function of reducing tension experienced by the upper wall during compression, the tension relief zones may also equalize a tension experienced by the upper wall overlying each gas chamber as compared to the tension experienced by the upper wall overlying the other gas chambers upon compression thereof.

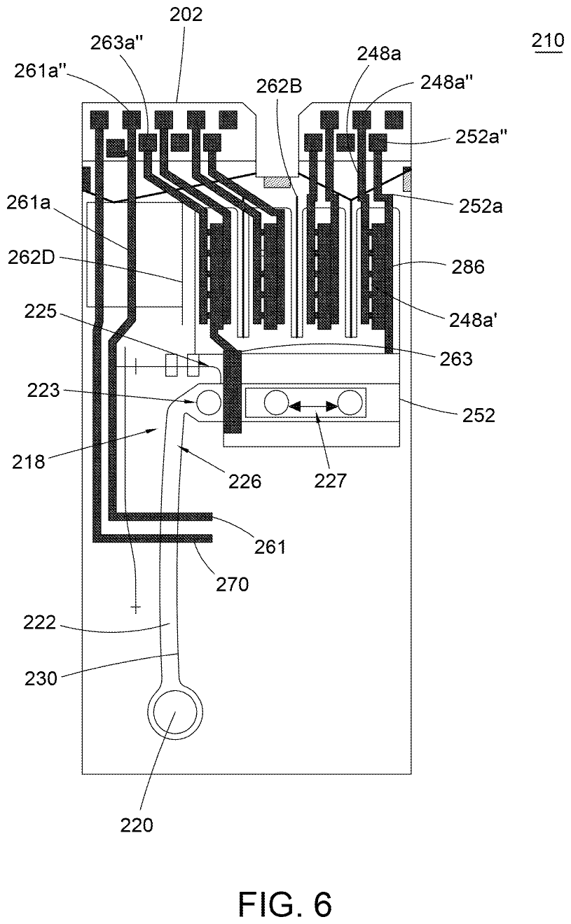

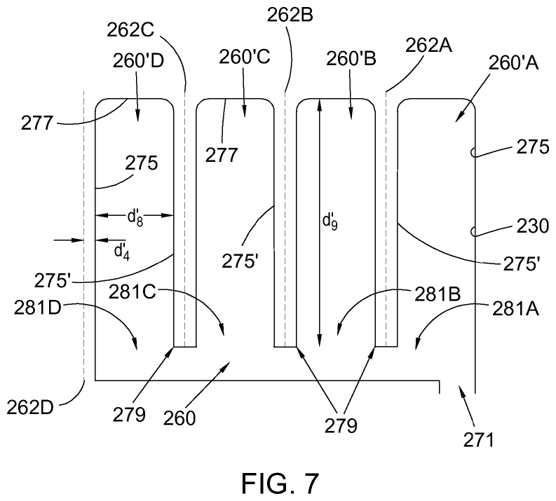

Referring to FIGS. 6 and 7, a microfluidic strip 210 includes a microfluidic network 218. Reader 111 operates strip 210 to determine the presence and/or amount of at least one target (e.g., a biomolecule such as a protein) present in a sample liquid applied to strip 10. For example, strip 210 may be configured and operated to determine any of the targets disclosed in the '325 application.

Microfluidic strip 210 is composed of a lower substrate, e.g., a flexible polymer layer, an upper substrate, e.g., a flexible polymer layer, adhered in opposition by an adhesive layer as disclosed for microfluidic strip 10. The adhesive layer occupies less than all of the area of opposing surfaces between the upper and lower substrates and includes side walls 230 to define microfluidic channel network 218 therebetween as disclosed for adhesive layer 16 and sidewalls 30 of microfluidic strip 10. The upper and lower substrates and adhesive layer may have the same properties (e.g., thickness, extent with respect to the area of microfluidic strip 210, composition) as disclosed for upper and lower substrates 12,14 and adhesive layer 16 of microfluidic strip 10.

Proceeding distally from a liquid sample input port 220 of microfluidic network 218, microfluidic network 218 includes a single analysis channel 226 having a supply channel 222, a first reagent zone 223, a vent 225, a combined reagent detection zone 227, and a gas chamber 260. Gas chamber 260 includes a plurality of spaced apart locations (gas chamber branches) 260′A, 260′B, 260′C, 260′D. The term “spaced apart location” may be interchangeably used with the term “gas chamber branch” herein. Each of spaced apart locations 260′A, 260′B, 260′C, 260′D is spaced apart from an adjacent spaced apart location by an internal side wall 279 which permit the upper lay overlying each spaced apart location to be compressed/decompressed and/or oscillated independently of the upper layer overlying the other spaced apart locations. In the absence of the internal side walls 279, the upper layer might sag and therefore lack sufficient tension to be oscillated as disclosed herein. The upper layer overlying the spaced apart locations includes tension relief zones 262A, 262B, 262C, 262D that equalizes tension of the layer overlying adjacent spaced apart locations during compression, decompression, and/or oscillation. Each of spaced apart locations 260′A, 260′B, 260′C, 260′D is in gaseous communication with the other of the spaced apart locations via a respective opening 281A, 281B, 281C, 281D. Gas chamber 260 is in gaseous communication with proximal locations of analysis channel 226 via an opening 271. Each spaced apart location 260′A, 260′B, 260′C, 260′D has a width d′8 between about 0.5 mm to about 20 mm, between about 1 mm to about 15 mm, between about 2 mm to about 15 mm, or of about 4 mm. Each spaced apart location 260′A, 260′B, 260′C, 260′D has and a length d′9 between about 0.5 mm to about 30 mm, between about 1 mm to about 20 mm, between about 5 mm to about 15 mm, or of about 11.5 mm.

Each tension relief zone 262A-262D may be aligned with a portion of a side wall (e.g., d′9) of one or more spaced apart locations. One or more tension relief zones, such as 262A, 262B, and/or 262C may be aligned with a side wall from two adjacent spaced apart locations.

Each tension relief zone may track a shape of a sidewall of a spaced apart location, such as being in a straight line. Each tension relief zone may be in any shape or configuration, spanning at least a portion of a sidewall of a spaced apart location (e.g., d′9). For example, each tension relief zone may be configured in a straight line, curved, arcuate, zig-zagged, at an angle (as compared to a longitudinal axis to one or more sidewalls of a spaced apart location), or any combination thereof.

In some cases, a separation distance between centers of two sections of the upper layer overlaying two spaced apart locations is based on a width of a corresponding tension relief zone therebetween. In some cases, the separation distance between said centers varies based on decompression and/or compression of the corresponding upper layer. For example, compressing one or both of a section of an upper layer overlying a spaced apart location may decrease a width of a tension relief zone and thereby a separation distance between the centers therebetween, where decompressing may increase said separation distance.

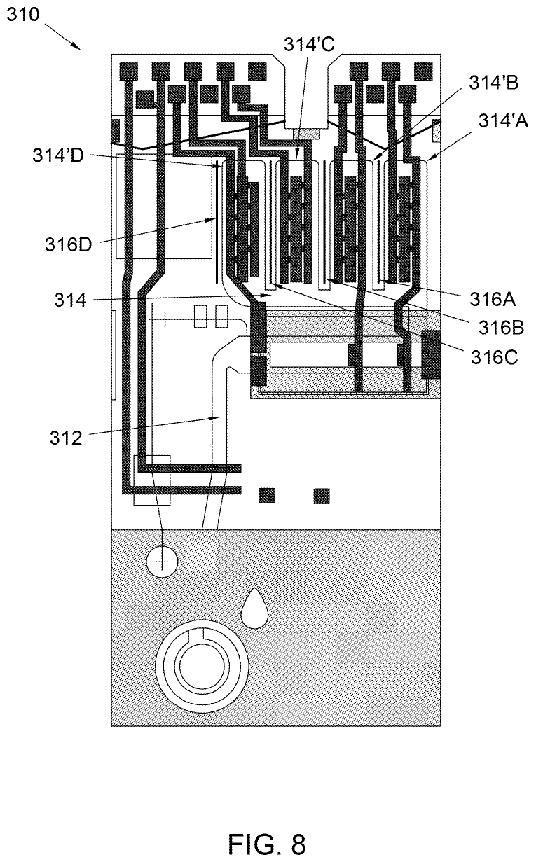

FIG. 8 depicts another exemplary embodiment of a microfluidic strip 310 (similar to strip 210) having a microfluidic network, comprised of a single analysis channel 312 as described herein, configured to determine the presence and/or amount of at least one target (e.g., a biomolecule such as a protein) present in a sample liquid applied to strip. For example, strip 310 may be configured and operated to determine any of the targets disclosed in the '325 application. In some cases, the strip 310 is configured and operated to determine the presence of a COVID (e.g., COVID-19) antibody. The strip 310 further comprises a gas chamber 314 that includes a plurality of spaced apart locations 314′A, 314′B, 314′C, 314′D, similar to strip 210 as described herein. The corresponding upper layer overlying the spaced apart locations includes tension relief zones 316A, 316B, 316C, 316D that equalizes tension of the layer overlying adjacent spaced apart locations during compression, decompression, and/or oscillation (as described herein).

First reagent zone 223 includes a regent configured to reduce coagulation of blood present in a liquid sample, e.g., lithium heparin. Combined reagent detection zone 227 includes reagents configured to facilitate detection of a target, e.g., reagents configured to bind to a target and labeled to permit detection of such reagents. The reagents may also include a magnetic particle reagent to permit the magnetic capture of the reagents as disclosed, e.g., in the '325 application.

The upper substrate overlying each of the spaced apart locations 260′A, 260′B, 260′C, 260′D is independently compressible, decompressible and/or capable of being oscillated at each spaced apart location by a flow controller of reader 111 to move liquid sample within microfluidic network 218 and/or facilitate mixing of the liquid sample with reagents within the microfluidic network 218. For example, the compression, decompression, and/or oscillation may be performed using a piezoelectric actuator having an actuation foot to compress, decompress, and/or oscillate the upper substrate overlying each of the respective spaced apart locations. The actions of compressing or decompressing and of oscillating the upper wall of each spaced apart location of gas chamber 260 may be performed independently or in combination. Typically, the upper substrate overlying each of the spaced apart locations 260′A, 260′B, 260′C, 260′D is compressed (and optionally oscillated), decompressed (and optionally oscillated), or oscillated in synchronization with the upper substrate overlying each of the other spaced apart locations. The oscillating may be performed at an acoustic frequency, e.g., any of the acoustic frequencies disclosed herein. A volume of each of spaced apart locations 260′A, 260′B, 260′C, 260′D between a distal inner side wall 277 and respective opening 281A, 281B, 281C, 281D is about the same as the volume of a single gas chamber 60A, 60B, 60C, 60D of strip 10. Accordingly, the synchronous compression, decompression, and/oscillation of the spaced apart locations 260′A, 260′B, 260′C, 260′D displaces and/or oscillates a volume of gas that is at least about 4 times as large as the corresponding displacement and/or oscillation of gas within a single gas chamber 60A, 60B, 60C, 60D of strip 10. Because gas chamber 260 is in gaseous communication with a single analysis channel 226, and with a liquid-gas interface of a liquid sample present therein, the actuation of gas chamber 260 can move liquid sample at higher rates within microfluidic network 218 and/or achieve more efficient mixing than can be achieved within microfluidic network 18 of strip 10. For example, strip 210 and reader 111 can perform a determination of the presence of a target, e.g., a pathogen such as a coronavirus pathogen, within 5 minutes of the application of a liquid sample containing such target to sample input port 220.

Strip 210 includes, as discussed for strip 10, electrodes disposed and configured to permit reader 111 to monitor the proper filling of strip 210 with sample liquid, the proper movement of sample liquid within strip 10 and the operation (e.g., the compression state) of each spaced apart location 260′A, 260′B, 260′C, 260′D. In brief, strip 210 includes a supply electrode 270 and first, second, and third fill electrodes 261,263,252 disposed at spaced apart locations within analysis channel 226. Supply electrode 270 emits an electrical signal that are received by respective fill electrodes 261,263,252 when sample liquid occupies the microfluidic network therebetween as disclosed in the '325 application. Each of analysis channel fill electrodes 261,263,252 is connected via a respective lead 261a, 263a, 252a to a respective contact 261a″, 263a″, 252a″ located adjacent a distal periphery 202 of strip 210. When strip 210 is fully inserted into reader 111, contacts 261a″, 263a″, 252a″ of leads 261a, 263a, 252a engage corresponding contacts (not shown) within reader 111. The engaged contacts permit reader 111 to deliver and/or receive electrical signals to and/or from supply electrode 270 and fill electrodes 261,263,252 to determine the presence of liquid sample at the locations within microfluidic network 218 as disclosed in the '325 application.

Each of spaced apart locations 260′A, 260′B, 260′C, 260′D includes electrical elements that permit reader 111 to determine independently of the other spaced apart locations whether such spaced apart location is in an operatively fully compressed state. For example, portions of lead 248a and lead 252a pass along an internal surface of spaced apart location 260′A and an opposing internal surface of spaced apart location 260′A includes an electrically conductive bridging contact 286. When the upper wall overlying spaced apart location 260′A is operatively fully compressed, bridging contact 286 establishes continuity between the lead portions of leads 248a,252a, which are otherwise are not in direct continuity with one another. Reader 111 delivers and/or receives electrical signals to and/or from contacts 248a″,252″ indicative of the fully compressed state of spaced apart location 260′A.

In use, strip 210 is inserted into input port 113 of reader 111 into an operative position. The flow controller of reader 111 compresses the upper layer overlying each of spaced apart locations 260′A, 260′B, 260′C, 260′D expelling gas from gas chamber 260 and out of microfluidic network 218 via input port 220 and vent 223. A liquid sample is applied to input port 220 and flows along channel 222 via capillary action until a liquid-gas interface of the liquid sample reaches vent/capillary stop 223. The gas of the liquid-sample interface is in communication with gas chamber 260 by portions of analysis channel 226 located distal to the liquid-gas interface and by opening 271 to gas chamber 260. The flow controller decompresses, e.g., synchronously, the upper wall overlying each of spaced apart locations 260′A, 260′B, 260′C, 260′D to increase the volume of gas chamber 260, thereby decreasing a pressure of gas therein. Because gas chamber 260 is in gaseous communication with the liquid-gas interface, the decreased gas pressure draws the liquid-gas interface and the trailing liquid sample along analysis channel until the liquid-gas interface contacts liquid sensing electrode 263. Reader 111 receives an electrical signal from contact 263a″ indicative of the presence of liquid and ceases decompression. The sample liquid begins to mobilize reagent present in reagent zone 223. The flow controller of reader 111 synchronously oscillates the upper walls overlying the spaced apart locations of gas chamber 260 to synchronously oscillate the pressure of the gas therein. Because the gas is in communication with the liquid-gas interface of the liquid sample, the oscillations transfer energy to the liquid enhancing mixing of the liquid sample with reagents within the reagent zone 223. After an incubation period, the flow controller again decompresses the upper wall overlying each spaced apart location drawing the liquid sample toward the gas chamber until the trailing liquid sample contacts reagents within combined reagent/detection zone 227 and the liquid-gas interface contacts liquid sensing electrode 252. Upon receiving an electrical signal from contact 252a″ that liquid has contacted electrode 252, the flow controller again ceases decompression. The flow controller again synchronously oscillates the upper walls overlying the spaced apart locations of gas chamber 260 to enhance mixing of the liquid sample and reagents within reagent/detection zone 227. After an incubation period, a magnetic actuator of reader 111 captures magnetic reagents within reagent/detection zone 227. Then, the flow controller compresses, e.g., synchronously, each the spaced apart locations to expel gas from gas-filed chamber 260 driving the liquid-gas interface and liquid sample proximally towards input port 220 until the gas-liquid interface moves proximally beyond liquid sensing electrode 263. Removing the sample also removes labelled reagents that have not bound to target and the magnetic reagent. Once the liquid sample and unbound reagents have been removed, the reader 111 detects the presence of magnetic reagent in reagent/detection zone 227.

The compression, decompression and/or oscillation of each spaced apart location may be performed using a respective piezoelectric actuator having an actuation foot to independently compress, decompress and/or oscillate, e.g., synchronously, the upper wall overlying each spaced apart location of gas chamber 260. Accordingly, each upper wall may independently be compressed, decompressed, and/or oscillated, such that each section of an upper layer overlying a corresponding spaced apart location may be calibrated independently to obtain a desired tension during compression and/or decompression.

### Exemplary Embodiments

Embodiment 1: A microfluidic device, comprising: a generally planar substrate comprising a microfluidic network therein, the microfluidic network comprising (i) an input port, a chamber, e.g., a gas chamber, and at least one channel extending between the input port and the chamber and (ii) a polymer layer overlying or underlying the chamber and at least a portion of the channel, wherein the polymer layer overlying or underlying the chamber is compressible along an axis perpendicular to a major plane of the substrate to reduce an internal volume of the chamber and the polymer layer comprises at least one tension relief zone disposed at or adjacent a perimeter of the chamber and configured to decrease a tension within the polymer layer overlying or underlying the chamber upon compression of the polymer layer.

Embodiment 2: The microfluidic device of embodiment 1, wherein, apart from the tension relief zone, the polymer layer has a primary thickness along the axis perpendicular to the major plane of the substrate of between about 50 μm and 150 μm and, within the tension relief zone, the polymer layer has a thickness of from about 0% to about 75% of the primary thickness, e.g., a thickness of from about 0% to about 50% of the primary thickness, a thickness of from about 0% to about 25% of the primary thickness, a thickness of from about 0% to about 15% of the primary thickness, or a thickness of less than about 5% of the primary thickness.

Embodiment 3: The microfluidic device of embodiment 1 or 2, wherein the tension relief zone comprises one or more laser ablation zones.

Embodiment 4: The microfluidic device of any of the foregoing embodiments, wherein the tension relief zone comprises a slit extending entirely through the polymer layer along the axis perpendicular to the major plane of the substrate.

Embodiment 5: The microfluidic device of any of the foregoing embodiments, wherein internal side walls of the chamber define a perimeter of the chamber and the tension relief zone extends for a total distance of at least about 40%, at least about 50%, at least about 60%, or at least about 70% of the perimeter.

Embodiment 6: The microfluidic device of embodiment 5, wherein the perimeter has a total length of at least about 1 cm, at least about 2 cm, at least about 3 cm, at least about 4 cm, or at least about 5 cm.

Embodiment 7: The microfluidic device of any of the foregoing embodiments, wherein the one or more tension relief zones are disposed within a distance d4 of the perimeter of the chamber, wherein distance d4 is about 3 mm or less, about 2 mm or less, about 1 mm or less, about 0.75 mm or less, or about 0.5 mm or less of the perimeter.

Embodiment 8: The microfluidic device of embodiment 7, wherein, in aggregate, at least about 25%, at least about 35%, at least about 45%, at least about 55%, or at least about 65% of the perimeter of the chamber includes a tension relief zone disposed within distance d4 of the perimeter thereof.

Embodiment 9: The microfluidic device of any of the foregoing embodiments wherein the polymer layer is a first polymer layer and the substrate comprises a laminate of the first polymer layer, a second polymer layer, and an adhesive layer, wherein the adhesive layer is disposed between the first and second polymer layers along the axis perpendicular to the major plane of the substrate and secures the first and second polymer layers with respect to one another.

Embodiment 10: The microfluidic device of embodiment 9, wherein the adhesive layer defines internal side walls of the microfluidic network.

Embodiment 11: The microfluidic device of embodiment 10, wherein the internal side walls are oriented generally parallel to the axis that is perpendicular to the major plane of the substrate.

Embodiment 12: The microfluidic device of any of embodiments 9-11, wherein the adhesive layer consists essentially of a single layer of adhesive having a first surface in contact with a surface of the first polymer layer and a second opposed surface in contact with a surface of the second polymer layer.

Embodiment 13: The microfluidic device of any of embodiments 9-12, wherein the perimeter of the chamber is defined by the internal walls therein by the adhesive layer.

Embodiment 14: The microfluidic device of any of embodiments 9-13, wherein a thickness of the adhesive layer along the axis that is perpendicular to the major plane of the substrate is between about 50 and 500 μm, between about 50 and 400 μm, between about 50 and 300 μm, between about 50 and 250 μm, between about 50 and 200 μm, between about 50 and 150 μm, or between about 50 and 125 μm.

Embodiment 15: The microfluidic device of any of the foregoing embodiments, wherein a thickness of the polymer layer that comprises the at least one tension relief zone along the axis that is perpendicular to the major plane of the substrate is between about 50 and 500 μm, between about 50 and 400 μm, between about 50 and 300 μm, between about 50 and 250 μm, between about 50 and 200 μm, between about 50 and 150 μm, or between about 50 and 125 μm.

Embodiment 16: The microfluidic device of embodiment 15, wherein an average depth of the tension relief zone along the axis that is perpendicular to the major plane of the substrate is at least about 50%, at least about 60%, at least about 70%, at least about 80%, at least about 90%, at least about 95% of the thickness of the polymer layer that comprises the at least one tension relief zone or the average depth of the tension relief zone along the axis that is perpendicular to the major plane of the substrate may be essentially the same as the thickness of the polymer layer that comprises the at least one tension relief zone.

Embodiment 17: The microfluidic device of embodiment 16, wherein at least about 50%, at least about 60%, at least about 70%, at least about 75%, at least about 85%, at least about 95%, or essentially all of the length of the tension relief zone extends essentially through, e.g., entirely through, the polymer layer that comprises the at least one tension relief zone along the axis that is perpendicular to the major plane of the substrate.

Embodiment 18: The microfluidic device of any of the foregoing embodiments, wherein the average thickness of the substrate along the axis that is perpendicular to the major plane of the substrate is about 2000 μm or less, about 1500 μm or less, about 1000 μm or less, about 750 μm or less, about 500 μm or less, about 400 μm or less, or about 350 μm or less.

Embodiment 19: The microfluidic device of any of the foregoing embodiments, wherein the maximum thickness of the substrate along the axis that is perpendicular to the major plane of the substrate is about 2000 μm or less, about 1500 μm or less, about 1000 μm or less, about 750 μm or less, about 500 μm or less, about 400 μm or less, or about 350 μm or less.

Embodiment 20: The microfluidic device of any of the foregoing embodiments, wherein a maximum difference between a minimum and maximum height of the substrate along the axis that is perpendicular to the major plane of the substrate is no greater than the average thickness of the substrate.

Embodiment 21: The microfluidic device of any of the foregoing embodiments, wherein a maximum difference between a minimum and a maximum height of the substrate along the axis that is perpendicular to the major plane of the substrate is about 1000 μm or less, about 750 μm or less, about 500 μm or less, about 400 μm or less, about 300 μm or less, about 275 μm or less, about 250 μm or less, or about 225 μm or less.

Embodiment 22: The microfluidic device of any of the foregoing embodiments, wherein the substrate has a surface area parallel to the major plane of the substrate and the polymer layer that comprises the at least one tension relief zone extends over at least about 50%, at least about 60%, at least about 70%, at least about 80%, at least about 90%, at least about 95%, or at least about 97.5% of the surface area.

Embodiment 23: The microfluidic device of any of the foregoing embodiments, wherein, excluding the input port, the substrate has a surface area parallel to the major plane of the substrate and, excluding the input port, the polymer layer that comprises the at least one tension relief zone extends over at least about 50%, at least about 60%, at least about 70%, at least about 80%, at least about 90%, at least about 95%, at least about 97.5%, or essentially all of the surface area.

Embodiment 24: The microfluidic device of any of the foregoing embodiments, wherein the input port is the only port of the substrate configured to receive liquids during operation of the device.

Embodiment 25: The microfluidic device of any of the foregoing embodiments, wherein, prior to use, the substrate contains no liquids.

Embodiment 26: The microfluidic device of any of the foregoing embodiments, wherein the substrate lacks any reservoir containing a liquid reagent configured to be combined with a sample liquid within the microfluidic network.

Embodiment 27: The microfluidic device of any of the foregoing embodiments, wherein the substrate is flexible.

Embodiment 28: The microfluidic device of embodiment 27, wherein the substrate can be flexed about a curve having a radius of curvature of about 5 cm or less, about 4 cm or less, about 3 cm or less, or about 2.5 cm without breaking and/or rendering the microfluidic device inoperative.

Embodiment 29: The microfluidic device of any of the foregoing embodiments, wherein the chamber has an internal height along the axis that is perpendicular to the major plane of the substrate of about 500 μm or less, about 400 μm or less, about 300 μm or less, about 250 μm or less, about 200 μm or less, about 150 μm or less or about 125 μm or less.

Embodiment 30: The microfluidic device of any of the foregoing embodiments, wherein the chamber has an internal height along the axis that is perpendicular to the major plane of the substrate of at least about 50 μm, at least about 75 μm, at least about 100 μm, or at least about 110 μm.

Embodiment 31: The microfluidic device of any of the foregoing embodiments, wherein the chamber has an internal area parallel to the major plane of the substrate of at least about 1 cm², at least about 1.5 cm², at least about 2 cm², or at least about 2.5 cm².

Embodiment 32: The microfluidic device of any of the foregoing embodiments, wherein the chamber has an internal area parallel to the major plane of the substrate of about 5 cm² or less, about 4 cm² or less, or about 3 cm² or less.

Embodiment 33: The microfluidic device of any of the foregoing embodiments, wherein the substrate is a flexible microfluidic strip.

Embodiment 34: A medical diagnostic instrument, comprising: a substrate of any of the foregoing embodiments disposed at least partially within the diagnostic instrument in an operable position; a chamber actuation mechanism configured to move liquid sample within the microfluidic network by compressing the chamber to expel gas from the chamber and into the microfluidic network or decompressing the chamber to draw gas from the microfluidic network into the chamber; and a detection system configured to detect a signal indicative of the presence of a target within a sample applied to the input port of the substrate.

Embodiment 35: A method of operating the microfluidic device of any of embodiments 1-33, comprising: compressing the chamber thereby expelling gas within the microfluidic network from the input port and increasing a width of the tension relief zone along a dimension parallel to the major plane of the strip.

Embodiment 36: The method of embodiment 35, further comprising: applying a liquid sample to the input port of the substrate; and decompressing the chamber thereby reducing a pressure of the gas within the microfluidic network and drawing the liquid sample along the microfluidic network toward the chamber and decreasing a width of the tension relief zone along the dimension parallel to the major plane of the strip.

Embodiment 37: The microfluidic device of any of the foregoing embodiments, wherein the chamber is a first chamber, the microfluidic network comprises a second chamber, the polymer layer comprising the at least one tension relief zone overlies or underlies the second chamber, an outer surface of the polymer layer overlying or underlying the second chamber is compressible along the axis perpendicular to the major plane of the substrate to reduce an internal volume of the second chamber and the polymer layer comprises at least one tension relief zone disposed at or adjacent a perimeter of the second chamber and configured to decrease a tension of the polymer layer overlying or underlying the second chamber upon compression of the polymer layer.

Embodiment 38: A generally planar medical diagnostic strip for use in detecting the presence of a target in a biological sample, the strip comprising: (i) a microfluidic network comprising an input port and a chamber; (ii) a polymer layer overlying the microfluidic network, wherein:
(a) the chamber comprises internal side walls defining a perimeter thereof; (b) the polymer layer comprises one or more slits extending at least 90% through the polymer layer, e.g., at least 95% through the polymer layer or entirely through the polymer layer, along an axis oriented perpendicular to a major plane of the strip, (c) the one or more slits are disposed within a distance d4 of the perimeter of the chamber, e.g., within about 2.5 mm, without about 1.75 mm, within about 1.25 mm, within about 0.75 mm, or within about 0.5 mm of the perimeter of the chamber, along an axis parallel to the major plane of the strip; (d) the one or more slits have an aggregate length of at least about 50%, at least about 60%, at least about 70%, or at least about 80%, of the length of the perimeter and disposed within the distance d4 from the chamber; and (e) the strip has a maximum thickness of about 1000 μm or less, about 750 μm or less, about 500 μm or less, or about 400 μm or less along the axis oriented perpendicular to the major plane of the strip.

Embodiment 39: A generally planar medical diagnostic strip for use in detecting the presence of a target in a biological sample, the strip comprising a microfluidic network, comprising: (i) an input port, a chamber, and at least one channel extending between the input port and the chamber; (ii) a polymer layer overlying or underlying the chamber and at least a portion of the channel, wherein: (a) the chamber comprises internal side walls defining a perimeter thereof;
(b) the polymer layer comprises one or more grooves extending at least 90% through the polymer layer, e.g., at least 95% through the polymer layer or entirely through the polymer layer, along an axis oriented perpendicular to a major plane of the strip, (c) the one or more grooves are disposed adjacent the perimeter of the chamber, e.g., within about 2.5 mm, without about 1.75 mm, within about 1.25 mm, within about 0.75 mm, or within about 0.5 mm of the perimeter of the chamber, along an axis parallel to the major plane of the strip;
(d) the one or more grooves have an aggregate length of at least about 50%, at least about 60%, at least about 70%, or at least about 80%, of the length of the perimeter; and
(e) the strip has a maximum thickness of about 1000 μm or less, about 750 μm or less, about 500 μm or less, or about 400 μm of less along the axis oriented perpendicular to the major plane of the strip.

Embodiment 40: A medical diagnostic strip for use in detecting the presence of a target in a biological sample, the strip comprising: a first generally planar substrate portion comprising a first generally planar major surface comprising (i) a first portion having a first thickness along an axis perpendicular to a major plane of the first generally planar substrate portion and a recessed portion having a second thickness along the axis perpendicular to a major plane of the first generally planar substrate portion, the second thickness being smaller than the first thickness; and a second generally planar substrate comprising (i) a first generally planar major surface comprising a contact portion secured to the first portion of the first generally planar substrate portion and an opposing portion opposing the recessed portion of the first generally planar substrate portion, the opposing portion and the recessed portion defining a microfluidic network therebetween and (ii) one or more slits extending through the contact portion along the axis perpendicular to a major plane of the first generally planar substrate portion and disposed adjacent the opposing portion.

Embodiment 41: A microfluidic device, comprising: a substrate comprising therein a microfluidic network, the microfluidic network comprising a gas chamber; wherein the gas chamber comprises: a first wall and a second wall disposed in opposition to the first wall, wherein at least one of the first and second walls of the gas chamber, at each of a plurality of spaced-apart locations in gaseous communication within the gas chamber with the other spaced apart locations, is compressible from an operatively uncompressed relaxed state in which the first and second walls are spaced apart within the gas chamber by a first distance and an operatively fully compressed state in which the first and second walls are spaced apart within the gas chamber by a second distance smaller than the first distance; and operatively associated with each of the spaced apart locations: a respective first electrically conductive element and a respective second electrically conductive element, wherein an electrical conductivity between the respective first and second electrically conductive elements associated with each spaced apart location is detectably different in the compressed state and the uncompressed state of such spaced apart location.

Embodiment 42: The microfluidic device of embodiment 41, wherein the microfluidic network comprises a sample input port and the gas chamber includes a single outlet in gaseous communication with the sample input port.

Embodiment 43: The microfluidic device of embodiment 42, wherein the microfluidic network comprises a reagent zone comprising one or more reagents, which may be in a dry or lyophilized state, configured to bind to a target in a biological sample.

Embodiment 44: The microfluidic device of embodiment 43, wherein each of the one or more reagents is disposed in a portion of the microfluidic network in gaseous communication with the sample input port and the outlet of the gas chamber.

Embodiment 45: The microfluidic device of embodiment 43 or embodiment 44, wherein one or more of the reagents is configured to bind a target that is indicative of the presence of a (i) pathogen or (ii) a cardiometabolic disorder or condition in a liquid sample applied to the sample input port.

Embodiment 46: The microfluidic device of any of embodiments 43-45, wherein one or more of the reagents comprises a detectable label, e.g., a fluorescent or electrochemically detectable label.

Embodiment 47: The microfluidic device of any of embodiments 41-46, wherein the first distance within the gas chamber at each of the spaced apart locations between the first and second walls in the uncompressed state is about 500 μm or less, about 400 μm or less, about 300 μm or less, about 200 μm or less, about 150 μm or less, about 125 μm or less, or about 100 μm or less.

Embodiment 48: The microfluidic device of any of embodiments 41-47, wherein the first distance within the gas chamber at each of the spaced apart locations between the first and second walls in the uncompressed state is about 25 μm or more, about 50 μm or more, about 75 μm or more, about 100 μm or more, about 125 μm or more, or about 150 μm or more.

Embodiment 49: The microfluidic device of any of embodiments 41-48, wherein the second distance within the gas chamber at each of the spaced apart locations between the first and second walls in the compressed state is about 10 μm or less, about 7.5 μm or less, about 5 μm or less, about 2.5 μm or less or essentially zero.

Embodiment 50: The microfluidic device of embodiment 49, wherein the first and second walls at each of the spaced apart locations are in direct contact within the gas chamber in the compressed state.

Embodiment 51: The microfluidic device of embodiment 49 or 50, wherein the first and second electrically conductive elements associated with each respective spaced apart location are in electrical communication with one another, e.g., in direct or indirect electrical communication, when the spaced apart location is in one of the compressed or uncompressed states but not the other of the compressed or compressed states.

Embodiment 52: The microfluidic device of any of embodiments 48-51, wherein one of the first and second walls at each of the spaced apart locations comprises a respective electrically conductive member, the other of the first and second walls at each of the spaced apart locations comprises the first and second electrically conductive elements associated with such spaced apart location, and when such spaced apart location is in the compressed state, the first and second electrically conductive elements associated with such spaced apart location are in indirect electrical communication via the respective electrically conductive member associated with such spaced apart location.

Embodiment 53: The microfluidic device of any of embodiments 41-52, wherein each of the spaced apart locations is partially separated within the interior the gas chamber from the other spaced apart locations by at least one internal side wall extending between the first and second walls.

Embodiment 54: The microfluidic device of any of embodiments 41-53, wherein the microfluidic device comprises a plurality of electrical contacts, wherein each electrical contact is in electrical communication with a respective first or second electrically conductive element.

Embodiment 55: The microfluidic device of any of embodiments 41-54, wherein the microfluidic network of the microfluidic device comprises a first electrode (i) disposed within the microfluidic network at a location other than the gas chamber and (ii) in electrical communication with at least one of the electrically conductive elements associated with one of the spaced apart locations.

Embodiment 56: The microfluidic device of any of embodiments 41-55, wherein the microfluidic network of the microfluidic device comprises a second electrode (i) disposed within the microfluidic network at a location other than the gas chamber or the location of the first electrode and (ii) in electrical communication with at least one of the electrically conductive elements associated with one of the spaced apart locations, wherein the first and second electrodes are in electrical communication with different electrically conductive elements.

Embodiment 57: The microfluidic device of any of embodiments 41-56, wherein the microfluidic network of the microfluidic device comprises a third electrode (i) disposed within the microfluidic network at a location other than the gas chamber or the locations of the first or second electrodes and (ii) in electrical communication with at least one of the electrically conductive elements associated with one of the spaced apart locations, wherein the first, second and third electrodes are in electrical communication with different electrically conductive elements.

Embodiment 58: The microfluidic device of any of embodiments 50-57, wherein the location within the microfluidic network of the first electrode is a first electrode distance along the microfluidic network from the input port, the location within the microfluidic network of the second electrode is a second electrode distance along the microfluidic network from the input port, and the location of the third electrode within the microfluidic network is a third electrode distance along the microfluidic network from the input port and the first electrode distance is less than the second electrode distance which is less than the third electrode distance.

Embodiment 59: The microfluidic device of any of embodiments 50-58, wherein the respective locations within the microfluidic network of at least two of the first, second, and third electrodes are spaced apart by a portion of the microfluidic channel comprising a reagent of any of embodiments 43-46.

Embodiment 60: The microfluidic device of any of embodiments 41-59, wherein the substrate is a microfluidic strip.

Embodiment 61: The microfluidic device of any of embodiments 41-60, wherein the substrate has a maximum thickness along an axis perpendicular to a major plane of the substrate of about 2000 μm or less, about 1500 μm or less, about 1000 μm or less, about 750 μm or less, about 500 μm or less, or about 400 μm or less.

Embodiment 62: The microfluidic device of any of embodiments 41-61, wherein the substrate has a maximum thickness along an axis perpendicular to a major plane of the substrate of at least about 50 μm, at least about 150 μm, at least about 250 μm, or at least about 300 μm, e.g., a maximum thickness of about 325 μm.

Embodiment 63: The microfluidic device of any of embodiments 41-62, wherein when the first and second walls at each of the spaced apart locations are in the uncompressed state, a ratio of a total volume of gas occupying the gas chamber to a total cross-sectional area in a plane perpendicular to a major plane of the substrate of an outlet of the gas chamber to the microfluidic network is at least about 15, at least about 20, at least about 25, at least about 30, at least about 35, at least about 40, at least about 50, at least about 60, or at least about 75.

Embodiment 64: The microfluidic device of any of embodiments 41-63, wherein when the first and second walls at each of the spaced apart locations are in the uncompressed state, a ratio of a total volume of gas occupying the gas chamber to a total cross-sectional area in a plane perpendicular to a major plane of the substrate of an outlet of the gas chamber to the microfluidic network is about 150 or less, about 125 or less, about 100 or less, about 90 or less, or about 80 or less.

Embodiment 65: The microfluidic device of any of embodiments 41-64, wherein the microfluidic network comprises an amount of a liquid sample disposed within the microfluidic network, the liquid of the sample liquid and a gas in gaseous communication with the gas of the gas chamber form a liquid-gas interface within the microfluidic network, and a ratio of a total volume of gas occupying the gas chamber to a total cross-sectional area in a plane perpendicular to a major plane of the substrate of the microfluidic network at the location occupied by the gas-liquid interface is at least about 15, at least about 20, at least about 25, at least about 30, at least about 35, at least about 40, at least about 50, at least about 60, or at least about 75.

Embodiment 66: The microfluidic device of any of embodiments 41-65, wherein the microfluidic network comprises an amount of a liquid sample disposed within the microfluidic network, the liquid of the sample liquid and a gas in gaseous communication with the gas of the gas chamber form a liquid-gas interface within the microfluidic network, and a ratio of a total volume of gas occupying the gas chamber to a total cross-sectional area in a plane perpendicular to a major plane of the substrate of the microfluidic network at the location occupied by the gas-liquid interface is about 150 or less, about 125 or less, about 100 or less, about 90 or less, or about 80 or less.

Embodiment 67: The microfluidic device of any of embodiments 41-66, wherein the at least one of the first and second walls at each of the spaced apart locations is independently compressible from the uncompressed state to the compressed state without substantially compressing the at least one of the first and second walls of the other of the spaced apart locations.

Embodiment 68: The microfluidic device of any of embodiments 41-67, wherein the at least one of the first and second walls at each of the spaced apart locations is independently compressible from the uncompressed state to the compressed state without substantially reducing the distance within the gas chamber by which the first and second walls at the other spaced apart locations are spaced apart from one another.

Embodiment 69: The microfluidic device of any of embodiments 41-68, wherein the at least one of the first and second walls at each of the spaced apart locations is independently compressible from the uncompressed state to the compressed state while at the same time the distance within the gas chamber by which the first and second walls at the other spaced apart locations are spaced apart from one another remains without about 90%, within about 95%, or within about 97.5% of the first distance.

Embodiment 70: The microfluidic device of embodiment 69, wherein the at least one of the first and second walls at each of the spaced apart locations is independently compressible from the uncompressed state to the compressed state while at the same time the distance within the gas chamber by which the first and second walls at the other spaced apart locations are spaced apart from one another remains essentially the same as, or the same as, the first distance.

Embodiment 71: A method of using the microfluidic device of any of embodiments 41-70, comprising: compressing at least one of the first and second walls at each of the plurality of locations; detecting a respective an electrical signal from at least one of the respective first and second electrically conductive elements operatively associated with each of the spaced locations, wherein each electrical signal indicates that the first and second walls associated with the respective spaced apart location are in the compressed state.

Embodiment 72: The method of embodiment 71, further comprising: following the step of detecting, decompressing the at least one of the first and second walls at each of the plurality of locations at least until the electrical signal indicates that the first and second walls associated with each of the respective spaced apart locations are no longer in the compressed state.

Embodiment 73: The method of embodiment 72, further comprising: after the step of decompressing, introducing a liquid sample into the microfluidic network of the microfluidic device; forming a liquid-gas interface within the microfluidic network wherein the liquid of the liquid-gas interface is the sample liquid introduced to the microfluidic network and the gas of the liquid-gas interface is in gaseous communication with the gas of the gas chamber; allowing the liquid sample to flow along a portion of the microfluidic network of the microfluidic device via capillary action; stopping the flow of the liquid sample along the microfluidic network; and after the stopping the flow of the liquid sample, simultaneously further decompressing the first and second walls associated with each of the plurality of spaced apart locations thereby reducing a pressure of the gas of the liquid-gas interface and moving the liquid-gas interface along the microfluidic network toward the gas chamber.

Embodiment 74: The method of embodiment 73, comprising: moving the liquid-gas interface along the microfluidic network toward the gas chamber until the liquid of the liquid-gas interface contacts one of the first, second, or third electrodes of any of embodiments 55-59; detecting a respective electrical signal indicative of the contact of the liquid and the first, second, or third electrodes, and ceasing the decompressing the first and second walls of each of the plurality of spaced apart locations, thereby ceasing the movement of the liquid-gas interface toward the gas chamber.

Embodiment 75: A method of using the microfluidic device of any of embodiments 41-70, comprising: oscillating, optionally synchronously, the distance spacing apart the respective first and second walls within the gas chamber at each of the plurality of spaced apart locations at a frequency of at least about 100 Hz, at least about 200 Hz, at least about 300 Hz, at least about 400 Hz, at least about 500 Hz, at least about 600 Hz, at least about 700 Hz.

Embodiment 76: The method of embodiment 75, wherein the frequency of oscillation is an acoustic frequency.

Embodiment 77: The method of embodiment 75 or 76, wherein the frequency of oscillation is about 2000 Hz or less, about 1750 Hz or less, about 1500 Hz or less, about 1250 Hz or less, or about 1000 Hz or less.

Embodiment 78: The method of any of embodiments 75-77, wherein the oscillating the distance spacing apart the respective first and second walls comprises oscillating the distance spacing apart the respective first and second walls along an axis perpendicular to a major plane of the substrate.

Embodiment 79: The method of any of embodiments 75-78, wherein the oscillating the distance spacing apart the respective first and second walls comprises oscillating the distance spacing apart the respective first and second walls along an axis perpendicular to a major plane of the substrate by at least about 2.5 μm, at least about 5 μm, at least about 7.5 μm, or at least about 10 μm.

Embodiment 80: The method of any of embodiments 75-79, wherein the oscillating the distance spacing apart the respective first and second walls comprises oscillating the distance spacing apart the respective first and second walls along an axis perpendicular to a major plane of the substrate by about 50 μm or less, about 40 μm or less, or about 30 μm or less.

Embodiment 81: The method of any of embodiments 75-80, wherein the method further comprises: introducing a liquid sample into the microfluidic network of the microfluidic device; forming a liquid-gas interface within the microfluidic network wherein the liquid of the liquid-gas interface is the sample liquid and the gas of the liquid-gas interface is in gaseous communication with the gas of the gas chamber and wherein the oscillating the distance spacing apart the respective first and second walls oscillates a pressure of the gas of the liquid-gas interface.

Embodiment 82: The method of embodiment 81, wherein the method further comprises: contacting, within the microfluidic network, the liquid sample and any of the one or more reagents of any of embodiments 43-46, wherein the oscillating the gas of the liquid-gas interface induces mixing of the liquid sample and the one or more reagents.

Embodiment 83: The method of any of embodiments 71-82, wherein each of the spaced apart locations is partially separated within the interior the gas chamber from the other spaced apart locations by at least one internal side wall extending between the first and second walls.

Embodiment 84: The method of any of embodiments 71-83, wherein the oscillating comprises oscillating a total volume of gas occupying the gas chamber having a ratio to a total cross-sectional area in a plane perpendicular to a major plane of the substrate of an outlet of the gas chamber to the microfluidic network of at least about 15, at least about 20, at least about 25, at least about 30, at least about 35, at least about 40, at least about 50, at least about 60, or at least about 75.

Embodiment 85: The method of any of embodiments 71-84, wherein the oscillating comprises oscillating a total volume of gas occupying the gas chamber having a ratio to a total cross-sectional area in a plane perpendicular to a major plane of the substrate of an outlet of the gas chamber to the microfluidic network of about 150 or less, about 125 or less, about 100 or less, about 90 or less, or about 80 or less.

Embodiment 86: The method of any of embodiments 81-85, wherein the oscillating comprises oscillating a total volume of gas occupying the gas chamber having a ratio to a total cross-sectional area of the microfluidic network in a plane perpendicular to a major plane of the substrate at the location occupied by the gas-liquid interface of at least about 15, at least about 20, at least about 25, at least about 30, at least about 35, at least about 40, at least about 50, at least about 60, or at least about 75.

Embodiment 87: The method of any of embodiments 81-86, wherein the oscillating comprises oscillating a total volume of gas occupying the gas chamber having a ratio to a total cross-sectional area of the microfluidic network in a plane perpendicular to a major plane of the substrate at the location occupied by the gas-liquid interface of about 150 or less, about 125 or less, about 100 or less, about 90 or less, or about 80 or less.

Embodiment 88: A method of mixing a reagent and a liquid sample within a microfluidic network of a microfluidic device, comprising: oscillating, optionally synchronously, each of a plurality of spaced-apart locations of a wall of a gas chamber of the microfluidic device wherein the gas of the gas chamber is in gaseous communication with a liquid-gas interface of the liquid sample.

Embodiment 89: The method of embodiment 88, wherein, during the step of oscillating, the gas of the gas chamber is spaced apart from a sample input port of the microfluidic device by the liquid-gas interface.

Embodiment 90: The method of embodiment 88 or 89, wherein the oscillating is performed at one or more acoustic frequencies.

Embodiment 91: The method of any of embodiments 88-90, wherein the step of oscillating is performed by contacting a respective outer surface of the wall of each of the spaced apart locations using a respective mechanical and/or piezoelectric actuator.

Embodiment 92: The method of embodiment 91, wherein each of the respective mechanical actuators contacts an area of the outer surface of each respective portion of the wall of between about 1 mm² and 12 mm², of between about 3 mm² and 10 mm², of between about 4 mm² and 8 mm², or between about 5 mm² and 7 mm², e.g., about 6 mm².

Embodiment 93: A method of moving a liquid within a microfluidic network of a microfluidic device, comprising: compressing each of multiple locations of a gas chamber of the microfluidic network thereby expelling at least some of the gas from within the microfluidic network from a sample input port of the microfluidic device; introducing a liquid sample to the sample input port of the microfluidic device, the liquid of the liquid sample and gas remaining within the microfluidic network forming a liquid-gas interface disposed therein between the sample input port and the gas chamber; decompressing each of the multiple locations of the gas chamber thereby reducing a pressure of the gas of the liquid-gas interface and drawing the sample liquid along the microfluidic network toward the gas chamber.

Embodiment 94: The method of embodiment 91, wherein the step of compressing comprises receiving a respective electrical signal associated with each of the spaced apart locations, each electrical signal being indicative of the compression state of a respective spaced apart location.

Embodiment 95: The method of embodiment 91 or 92, wherein the step of decompressing comprises: increasing a respective spacing between a first internal wall surface and a second internal wall surface associated with each spaced apart location by a total amount X; and during the step of increasing the respective spacing, oscillating, optionally synchronously the respective spacing between the first internal wall surface and the second internal wall surface associated with each spaced apart location by an amount Y, where X>Y.

Embodiment 96: The method of embodiment 93, wherein the oscillating is performed at an acoustic frequency.

Embodiment 97: The method of embodiment 93 or 94, wherein the step of oscillating the respective spacing between the first internal wall surface and the second internal wall surface associated with each spaced apart locations is performed synchronously with the other of the spaced apart locations.

Embodiment 98: The method of any of embodiments 91-95, wherein the step of compressing is performed by compressing an outer surface of a respective portion of a wall overlying or underlying each of the multiple locations of the gas chamber of the microfluidic network using a respective mechanical or piezoelectric actuator.

Embodiment 99: The method of embodiment 96, wherein each of the respective mechanical actuators contacts an area of the outer surface of each respective portion of the wall of between about 1 mm² and 12 mm², of between about 3 mm² and 10 mm², of between about 4 mm² and 8 mm², or between about 5 mm² and 7 mm², e.g., about 6 mm².

All publications, patents, patent applications and other documents cited in this application are hereby incorporated by reference herein in their entireties for all purposes to the same extent as if each individual publication, patent, patent application or other document were individually indicated to be incorporated by reference for all purposes. While various specific embodiments have been illustrated and described, the above specification is not restrictive. It will be appreciated that various changes can be made without departing from the spirit and scope of the present disclosure(s). Many variations will become apparent to those skilled in the art upon review of this specification.

What is claimed is:

1. A microfluidic device, comprising:
a generally planar substrate comprising a microfluidic network therein, the microfluidic network comprising (i) an input port, a gas chamber, and at least one channel extending between the input port and the gas chamber, and (ii) a polymer layer overlying or underlying the gas chamber and at least a portion of the channel, wherein the polymer layer overlying or underlying the gas chamber is compressible along an axis perpendicular to a major plane of the substrate to reduce an internal volume of the gas chamber, the polymer layer comprises at least one tension relief zone aligned with a side wall of the gas chamber and configured to decrease a tension within the polymer layer overlying or underlying the gas chamber upon compression of the polymer layer.

2. The microfluidic device of claim 1, wherein, apart from the at least one tension relief zone, the polymer layer has a primary thickness along the axis perpendicular to the major plane of the substrate of between about 50 μm and 150 μm and, within the tension relief zone, the polymer layer has a thickness of from about 0% to about 75% of the primary thickness, a thickness from about 0% to about 50% of the primary thickness, a thickness of from about 0% to about 25% of the primary thickness, a thickness of from about 0% to about 15% of the primary thickness, or a thickness of less than about 5% of the primary thickness.

3. The microfluidic device of claim 1 or 2, wherein the tension relief is formed using laser ablation.

4. The microfluidic device of any of the foregoing claims, wherein the at least one tension relief zone each comprises a slit extending entirely through the polymer layer along the axis perpendicular to the major plane of the substrate.

5. The microfluidic device of any of the foregoing claims, wherein internal side walls of the chamber define a perimeter of the chamber and the tension relief zone extends for a total distance of at least about 40%, at least about 50%, at least about 60%, or at least about 70% of the perimeter.

6. The microfluidic device of claim 5, wherein the perimeter has a total length of at least about 0.1 cm, at least about 0.3 cm, at least about 0.5 cm, at least about 1 cm, at least about 2 cm, at least about 3 cm, at least about 4 cm, or at least about 5 cm.

7. The microfluidic device of any of the foregoing claims, wherein the one or more tension relief zones are disposed within a distance d4 of the perimeter of the chamber, wherein distance d4 is about 3 mm or less, about 2 mm or less, about 1 mm or less, about 0.75 mm or less, or about 0.5 mm or less of the perimeter.

8. The microfluidic device of claim 7, wherein, in aggregate, at least about 25%, at least about 35%, at least about 45%, at least about 55%, or at least about 65% of the perimeter of the chamber includes a tension relief zone disposed within distance d4 of the perimeter thereof.

9. The microfluidic device of any of the foregoing claims, wherein a thickness of the polymer layer that comprises the at least one tension relief zone along the axis that is perpendicular to the major plane of the substrate is between about 50 and 500 μm, between about 50 and 400 μm, between about 50 and 300 μm, between about 50 and 250 μm, between about 50 and 200 μm, between about 50 and 150 μm, or between about 50 and 125 μm.

10. The microfluidic device of any of the foregoing claims, wherein the substrate has a surface area parallel to the major plane of the substrate and the polymer layer that comprises the at least one tension relief zone extends over at least about 50%, at least about 60%, at least about 70%, at least about 80%, at least about 90%, at least about 95%, or at least about 97.5% of the surface area.

11. A method of operating the microfluidic device of any of claims 1-10, comprising:
compressing the chamber thereby expelling gas within the microfluidic network from the input port and increasing a width of the tension relief zone along a dimension parallel to the major plane of the strip.

12. The method of claim 11, further comprising:
applying a liquid sample to the input port of the substrate; and
decompressing the chamber thereby reducing a pressure of the gas within the microfluidic network and drawing the liquid sample along the microfluidic network toward the chamber and decreasing a width of the tension relief zone along the dimension parallel to the major plane of the strip.

13. A microfluidic device, comprising:
a substrate comprising therein a microfluidic network, the microfluidic network comprising a gas chamber; wherein the gas chamber comprises:
a first wall and a second wall disposed in opposition to the first wall, wherein at least one of the first and second walls of the gas chamber, at each of a plurality of spaced-apart locations within the gas chamber, is compressible from an operatively uncompressed relaxed state in which the first and second walls are spaced apart within the gas chamber by a first distance and an operatively fully compressed state in which the first and second walls are spaced apart within the gas chamber by a second distance smaller than the first distance, the plurality of spaced apart locations in gaseous communication with each other; and
operatively associated with each of the spaced apart locations: a respective first electrically conductive element and a respective second electrically conductive element, wherein an electrical conductivity between the respective first and second electrically conductive elements associated with each spaced apart location is detectably different in the compressed state and the uncompressed state of such spaced apart location.

14. The microfluidic device of claim 13, wherein the microfluidic network comprises a sample input port, wherein the gas chamber includes a single outlet in gaseous communication with the sample input port.

15. The microfluidic device of claim 13 or 14, wherein each of the spaced apart locations is partially separated within the interior the gas chamber from the other spaced apart locations by at least one internal side wall extending between the first and second walls.

16. The microfluidic device of any of claims 13-15, wherein the at least one of the first and second walls at each of the spaced apart locations is independently compressible from the uncompressed state to the compressed state without substantially compressing the at least one of the first and second walls at the other the spaced apart locations.

17. A method of using the microfluidic device of any of claims 13-16, comprising:
oscillating the distance spacing apart the respective first and second walls within the gas chamber at each of the plurality of spaced apart locations at a frequency of at least about 100 Hz, at least about 200 Hz, at least about 300 Hz, at least about 400 Hz, at least about 500 Hz, at least about 600 Hz, at least about 700 Hz.

18. The method of claim 17, wherein the frequency of oscillation is about 2000 Hz or less, about 1750 Hz or less, about 1500 Hz or less, about 1250 Hz or less, or about 1000 Hz or less.

19. A method of mixing a reagent and a liquid sample within a microfluidic network of a microfluidic device, comprising:
oscillating each of a plurality of spaced-apart locations of a wall of a gas chamber of the microfluidic device wherein the gas of the gas chamber is in gaseous communication with a liquid-gas interface of the liquid sample.

20. The method of claim 19, wherein the step of oscillating is performed by contacting a respective outer surface of the wall of each of the spaced apart locations using a respective mechanical and/or piezoelectric actuator.
